(19) United States
(12) Patent Application Publication
(10) Pub. No.: US 2003/0115916 A1
(43) Pub. Date: Jun. 26, 2003

(54) Anti-theft brake or clutch pedal locking device

(76) Inventor: Robert A. Vito, Berwyn, PA (US)

Correspondence Address: OBERMAYER REBMANN MAXWELL & HIPPEL LLP, 1617 JOHN F KENNEDY BLVD, 19TH FLOOR, PHILIDELPHIA, PA, 19103, US

(21) Appl. No.: 10/357,026

(22) Filed: Feb. 3, 2003

Related U.S. Application Data
(63) Continuation of application No. 09/973,836, filed on Oct. 11, 2001.
Application No. 09/973,836 is a continuation-in-part of application No. 09/495,098, filed on Feb. 1, 2000, now Pat. No. 6,192,724.
Application No. 09/495,098 is a continuation-in-part of application No. 09/268,803, filed on Mar. 16, 1999, now Pat. No. 6,089,055.
Application No. 09/268,803 is a continuation-in-part of application No. 09/004,666, filed on Jan. 8, 1998, now Pat. No. 5,881,587.
Application No. 09/004,666 is a continuation-in-part of application No. 08/949,009, filed on Oct. 10, 1997, now Pat. No. 5,870,912.

(51) Int. Cl. B62H 5/14; B60R 25/00

(52) U.S. Cl. 70/225

(57) ABSTRACT

A device to lock a brake or clutch pedal of a vehicle that deters theft of the vehicle. The device includes a base for placement on a floor of the vehicle beneath the pedal of the vehicle and a pedal shaft supporting the pedal. A housing having an arm is attached to the base member. The arm has an opening therethrough. A rod is slidably disposed within the opening. The rod has a generally J-shaped end for receiving the pedal shaft. The rod is slidable within the arm so that the J-shaped end is movable between a raised position where the pedal cannot be depressed, and a retracted position, wherein the J-shaped end and is spaced from the clutch or brake pedal shaft. A locking mechanism is operably connected to the rod to fix the J-shaped end in at least the raised position.

### CLAIM OF PRIORITY

This application is a continuation-in-part of co-pending U.S. Pat. No. 6,192,724 filed Feb. 1, 2000, which is a continuation-in-part of U.S. Pat. No. 6,089,055 filed Mar. 16, 1999, which is a continuation-in-part of U.S. Pat. No. 5,881,587 filed Jan. 8, 1998, which is a continuation-in-part of U.S. Pat. No. 5,870,912 filed Oct. 10, 1997.

### BACKGROUND OF THE INVENTION

This invention relates to anti-theft brake or clutch pedal locking devices for vehicles which are particularly suitable for both automatic and standard transmission vehicles. More particularly, this invention relates to devices which prevent the brake or clutch pedal from being depressed, thereby rendering a vehicle inoperable.

Automotive theft is a major worldwide problem. The U.S. Federal Bureau of Investigation has reported that a car is stolen every 20 seconds.

The proliferation of mechanical type anti-theft devices for motor vehicles have resulted in the commercial availability of different types of anti-theft devices. One type of prior art system mechanically locks the brake and accelerator by means of two independent or articulated shoes which lock the pedals. The major problem stemming from the use of such devices is that the driver has to reach out for the pedal area or actually get down on his or her knees in order to operate the locking device, and the varying distance between the brake and accelerator which can prevent the device from being installed.

More recently, some devices have been suggested which are constructed from a long rod consisting of an anti-picking material and which is provided at both ends with two shaped members that couple respectively with a pedal and with the steering wheel of the vehicle. The coupling with the steering wheel is locked using a safety lock that prevents the same from being disengaged. This device, which owing to its characteristics, can be employed on traditional transmission cars as well as on automatic transmission vehicles, is affected in the main by two drawbacks.

First, the connection, due it longitudinal size and cumbersomeness is difficult to store when the device is not being utilized. Secondly, devices of this nature actually have a poor record against theft. Indeed, it is relatively easy to cut the rim of the steering wheel by means of a saw or the like. The rim of the steering wheel is usually not a viable obstacle for thieves, and the anti-theft device by can be disengaged merely pulling apart the two ends of the rim. Such devices are also not usually adaptable for automatic transmission vehicles because of their structural characteristics.

In UK patent application No. 2,091,656, an anti-theft pedal-locking device for vehicles is described comprising a first supporting member extending upwards and provided with a safety lock and with a laterally projecting member and a second supporting member, upon which the first supporting member slides. A projecting member cooperates with the corresponding member of the first supporting member so as to lock a pedal of the vehicle when the latter member is in its lower position, while the lower end of the second supporting member may carry a base member to rest on the floor of the vehicle.

A number of United States patents have also issued on brake locking mechanisms. U.S. Pat. No. 4,040,675 discloses a vehicle anti-theft device which maintains the braking function of the braking fluid by preventing reverse flow thereof from the wheel cylinder back to the master cylinder until an authorized procedure permits said backflow.

U.S. Pat. No. 4,493,198 discloses an anti-theft lock for a pedal operated apparatus. The invention incorporates first and second stop bodies which are arranged to clamp around the lever of a pedal. When the stop bodies are locked in place, the pedal cannot be operated unless the apparatus is restrained.

U.S. Pat. No. 4,934,492 discloses an automatic brake-locking mechanism which locks the brake of a vehicle having a hydraulic brake system. The system incorporates a safety switch provided to operate in conjunction with the ignition switch so that the safety switch and the ignition both must be operated to an “on” position to release the auxiliary brake device to allow normal operation of the vehicle.

U.S. Pat. No. 5,040,387 similarly discloses a vehicle brake lock assembly which engages a brake pedal and which includes a U-shaped end portion which engages the brake pedal telescopically to lock the brake pedal in position.

U.S. Pat. No. 5,345,796 discloses a vehicle brake-pedal locking device which mechanically maintains the vehicle brake pedal in a depressed position to prevent the vehicle from being driven. The device includes a horizontally and vertically pivoting brake-pedal swing arm interfacing structure.

Finally, U.S. Pat. No. 5,653,133 discloses an anti-theft device for vehicles having a steering wheel and a brake. The device comprises a brake guard moveably mounted to a fixed portion of the brake, a lower elongated member which hooks to the brake guard, an upper elongated member which is locked to the lower elongated member, a wide bar spaced a distance adaptable to be placed around the steering wheel and a locking bar and a claw member. When the device is secured with two padlocks, movement of the steering wheel and the brake pedal is prevented.

All of the above devices are so called active devices which must be actively placed on a vehicle. Passive alarms have also recently gained popularity, but these devices are expensive and frequently activate when a vehicle is accidentally struck. In addition to above discussed devices and technologies, the prior art also includes complex tracking devices which send out signals to police if a vehicle is reported stolen. The search may take up to 24 hours or longer with no guarantee of recovery. Installation of these systems is expensive and require a monthly monitoring fee. Automotive alarms are similarly expensive and may be deactivated by car thieves.

While the prior art is replete with mechanisms and inventions for locking the brake pedals of a vehicle, there is no simple and easy system devised for swiftly securing the brake or clutch pedal in a non-depressible state without the driver or operator having to get down on his or her knees or crouch down. Such a system would be to disable a vehicle, because many automobiles built since 1990 cannot start or cannot be placed into gear without the brake or clutch pedal being depressed.

The present invention is thus directed to a brake pedal or clutch pedal locking device, which does not require the driver or vehicle operator to get down on his knees or to move beneath the vehicle and which prevents the brake pedal or clutch pedal from being depressed. Disclosed herein are offer several different embodiments of the present invention for securing and locking the brake or clutch pedal. These embodiments are especially resistant to attempts by a thief or other unauthorized user from removing the brake or clutch pedal shaft from the device by damaging or otherwise tampering with the device. These embodiments are also convenient and easy to use. These and other objects of the present invention will be described with reference to the following summary and detailed description.

### SUMMARY OF THE INVENTION

In one aspect the invention is a device to lock a brake or clutch pedal of a vehicle so as to deter theft of the vehicle. The device includes a base for placement on a floor of the vehicle beneath the pedal of the vehicle and a pedal shaft supporting the pedal. A housing having an arm is attached to the base member. The arm has an opening therethrough. A rod is slidably disposed within the opening. The rod has a generally J-shaped end for receiving the brake or clutch pedal shaft, and the rod is slidable within the arm so that the J-shaped end is movable between a raised position where the brake or clutch pedal cannot be depressed, and a retracted position, wherein the J-shaped end is spaced from the clutch or brake pedal shaft. A locking mechanism is operably connected to the rod to fix the J-shaped end in at least the raised position.

In another aspect, the invention is a device to lock a brake or clutch pedal of a vehicle so as to deter theft of the vehicle. The device includes a generally U-shaped base for placement on a floor of the vehicle beneath the pedal of the vehicle and a pedal shaft supporting the pedal. A housing is attached to the base. A locking pin is selectively movable relative to the housing. The locking pin contacts the underside of the brake or clutch pedal and pulls it upwards in a decompressed fashion. A locking mechanism is operably connected to the locking pin to secure the locking pin with respect to the housing and prevent the pedal shaft from being depressed.

In another aspect, the invention is a device to lock a brake or clutch pedal of a vehicle so as to deter theft of the vehicle. The device includes a generally flat base for placement on a floor of the vehicle beneath the pedal of the vehicle and a pedal shaft supporting the pedal. The base has a top side parallel to a bottom side to define a thickness between the top side and the bottom side. A housing is attached to the base member. The housing includes a slot sufficiently large to receive the pedal shaft and permit full extension of the pedal shaft upward through the slot. A locking pin is selectively movable relative to the housing between a raised position sufficiently close to a lower side of the pedal shaft to prevent the pedal shaft from being depressed from the full extension position and a retracted position to permit travel of the pedal shaft through the slot. A locking mechanism coupled to the housing and operably connected to the locking pin fixes the locking pin in at least the raised position.

In another aspect, the invention is a device to lock a brake or clutch pedal of a vehicle so as to deter theft of the vehicle. The device includes a generally flat base for placement on a floor of the vehicle beneath the pedal of the vehicle and a pedal shaft supporting the pedal. The base has a top side parallel to a bottom side to define a thickness between the top side and the bottom side. A housing is attached to the base member. A locking pin selectively movable relative to the housing contacts the underside of the brake or clutch pedal and pulls it upwards in a decompressed fashion. A locking mechanism is operably connected to the locking pin to secure the locking pin with respect to the housing and to prevent the pedal shaft from being depressed. Additionally, at least three cleats extend perpendicularly from the bottom side of the base member.

In another aspect, the invention is a device to lock a brake or clutch pedal of a vehicle so as to deter theft of the vehicle. The device includes a base for placement on a floor of the vehicle beneath the pedal of the vehicle and a pedal shaft supporting the pedal. A housing is attached to the base member. A locking pin is selectively movable relative to the housing. The locking pin has a first end that contacts the underside of the brake or clutch pedal and pulls it upward in a decompressed fashion and a second end that is generally in the form of a dowel. A handle includes a hole for receiving the dowel. The hole is configured to form a complementary fit between the dowel and the hole. A locking mechanism is operably connected to secure the locking pin with respect to the housing and prevent the pedal shaft from being depressed.

In another aspect, the invention is a device to lock a brake or clutch pedal of a vehicle so as to deter theft of the vehicle. The device includes a base for placement on a floor of the vehicle beneath the pedal of the vehicle and a pedal shaft supporting the pedal. A housing has an arm attached to the base member. The arm has an opening therethrough. A rod is slidably disposed within the opening. A locking pin contacts the underside of the brake or clutch pedal shaft and pulls it upward in a decompressed fashion. The locking pin is securely fastened to one end of the rod. A locking mechanism is operably connected to the rod to secure the locking pin with respect to the housing and to prevent the pedal shaft from being depressed.

In another aspect, the invention is a device to lock a pedal of a vehicle so as to deter theft of the vehicle. The device includes a base for placement on a floor of the vehicle beneath the pedal of the vehicle and a pedal shaft supporting the pedal. A housing having an arm is attached to the base member. The arm has an opening therethrough. A rod is slidably disposed within the opening and has a serrated portion. The serrated portion includes a serration having a flat, radially-extending surface and a frusto-conical surface. A locking pin on one end of the rod contacts the underside of the pedal shaft and pulls it upward in a decompressed position. A ratchet pin for engaging the serration has a beveled end upon which is formed a notch. The beveled end is specifically configured to mate with the frusto-conical surface of the serration and the notch is formed to engage the flat radially-extending surface of the serration. A lock is coupled to the housing and operably connected to the ratchet pin so that when the lock is in a locked position the ratchet pin engages the serration in order to secure the locking pin with respect to the housing and prevent the pedal shaft from being depressed.

In another aspect, the invention is a device to lock a brake or clutch pedal of a vehicle so as to deter theft of the vehicle. The device includes a base for placement on the floor of a vehicle beneath the pedal of the vehicle and a pedal shaft supporting the pedal. A housing is attached to the base member. A locking pin selectively movable relative to the housing contacts the underside of the brake or clutch pedal and pulls it upwards in a decompressed fashion. A locking mechanism is operably connected to the locking pin in order to secure the locking pin with respect to the housing and prevent the pedal shaft from being depressed. Additionally, a plurality of gussets extend between the arm and the housing.

In another aspect the invention is a device to lock a brake or clutch pedal of a vehicle so as to deter theft of the vehicle. The device includes a base for placement on a floor of the vehicle beneath the pedal of the vehicle and a pedal shaft supporting the pedal. A housing is attached to the base. A locking pin selectively movable relative to the housing contacts the underside of the brake or clutch pedal shaft and pulls it upward in a decompressed position. A handle is disposed on an opposing end of the locking pin. The handle is made in one piece and has a shape selected from the group consisting of spheres, ellipsoids, one sheet hyperboloids, elliptic paraboloids, and elliptic cyclinders. A locking mechanism is operably connected to the locking pin to secure the locking pin with respect to the housing and prevent the pedal shaft from being depressed. In this aspect of the invention, the handle can also be in the form of a J-shape.

In another aspect the invention is a device to lock a brake or clutch pedal of a vehicle so as to deter theft of the vehicle. The device includes a base for placement on a floor of the vehicle beneath the pedal of the vehicle and a pedal shaft supporting the pedal. A housing having an arm is attached to the base. The arm has an opening therethrough. A rod is slidably disposed within the opening. A retaining block extends from the rod to define a space between the rod and the retaining block. The space is sufficiently large to receive the pedal shaft. The rod is slidable within the arm so that the retaining block is movable between a raised position where the brake or clutch pedal cannot be depressed, and a retracted position, wherein the retaining block is spaced from the clutch or brake pedal shaft. A locking mechanism is operably connected to the rod to fix the retaining block in at least the raised position.

In another aspect the invention is a device to lock a brake or clutch pedal of a vehicle so as to deter theft of the vehicle. The device includes a base for placement on a floor of the vehicle beneath the pedal of the vehicle and a pedal shaft supporting the pedal. A housing having an arm attached to the base member. The arm has an opening therethrough. A cross member extends from the arm. A hole is formed in the cross member. A rod is slidably disposed within the opening of the housing. A retaining post, configured to be positioned in the hole in the horizontal portion of the cross-member, extends from the rod to define a space between the rod and the retaining post. The space is sufficiently large to receive the pedal shaft. The rod is slidable within the arm so that the retaining post is movable between a raised position where the brake or clutch pedal cannot be depressed and the retaining post is positioned in the hole in the and a retracted position, wherein the retaining post is spaced from the arm and the clutch or brake pedal shaft. A locking mechanism is operably connected to the rod to fix the retaining post in at least the raised position.

In another aspect the invention is a device to lock a brake or clutch pedal of a vehicle so as to deter theft of the vehicle. The device includes a base for placement on a floor of the vehicle beneath the pedal of the vehicle and a pedal shaft supporting the pedal. The base has at least two intersecting rods. A housing attached to the base. A locking pin is selectively movable relative to the housing. The locking pin contacts the underside of the brake or clutch pedal shaft and pulls it upward in a decompressed position. A locking mechanism is operably connected to the locking pin to secure the locking pin with respect to the housing and prevent the pedal shaft from being depressed.

In another aspect the invention is a device to lock a brake or clutch pedal of a vehicle so as to deter theft of the vehicle. The device includes a base for placement on a floor of the vehicle beneath the pedal of the vehicle and a pedal shaft supporting the pedal. A housing having an arm attached to the base member. The arm has an opening therethrough. A descending member extends from the arm to define a space between the arm and the descending member. A locking pin, which is selectively movable relative to the housing, has an end that contacts the underside of the brake or clutch pedal and pulls it upward in a decompressed fashion. A ring extends from the locking pin. The ring is complementarily sized to slidably receive the descending member. A locking mechanism is operably connected to secure the locking pin with respect to the housing and prevent the pedal shaft from being depressed.

In another aspect the invention is a device to lock a brake or clutch pedal of a vehicle so as to deter theft of the vehicle. The device includes a generally X-shaped base for placement on a floor of the vehicle beneath the pedal of the vehicle and a pedal shaft supporting the pedal. A housing attached to the base. A locking pin is selectively movable relative to the housing. The locking pin contacts the underside of the brake or clutch pedal and pulls it upwards in a decompressed fashion. A locking mechanism is operably connected to the locking pin to secure the locking pin with respect to the housing and prevent the pedal shaft from being depressed.

### BRIEF DESCRIPTION OF THE FIGURES

FIG. 1 is a perspective view of the anti-theft device of a first preferred embodiment of the present invention;

FIG. 2 is a perspective view of the handle and lock pin utilized with the brake lock mechanism of the anti-theft device as shown in FIG. 1;

FIG. 3 is a perspective view of the anti-theft device shown in FIG. 1 in an inactive position;

FIG. 4 is a perspective view of the anti-theft device shown in FIG. 1 in an activated position;

FIG. 5 is a side elevational view of a second preferred embodiment of the anti-theft device of the present invention;

FIG. 6 is an elevational view of the second preferred embodiment of the anti-theft device of the present invention along line 6-6 of FIG. 5;

FIG. 7 is a perspective view of an alternative base embodiment for use in the second preferred embodiment shown in FIG. 5;

FIG. 8 is a front elevational view of a third preferred embodiment of the anti-theft device of the present invention;

FIG. 8A is a side elevational view of the anti-theft device shown in FIG. 8;

FIG. 8B is a side elevational view of the handle/rod/locking pin element of the anti-theft device shown in FIGS. 8 and 8A;

FIG. 9 is a perspective view of a fourth preferred embodiment of the anti-theft device of the present invention in an inactive position;

FIG. 10 is a front elevational view of the anti-theft device shown in FIG. 9;

FIG. 11 is a side elevational view of the anti-theft device shown in FIG. 9;

FIG. 12 is a perspective view of the anti-theft device shown in FIG. 9 with the locking pin in a fully retracted position;

FIG. 13 is a perspective view of the anti-theft device shown in FIG. 9, in an activated position with the locking pin raised;

FIG. 14 is a top plan view of a leg of the anti-theft device shown in FIG. 10, taken along line 14-14 of FIG. 10;

FIG. 15 is a side elevational view of the rod, handle and locking pin of the anti-theft device shown in FIG. 19;

FIG. 16 shows a banner on a steering wheel;

FIG. 17 is a front elevational view of a fifth preferred embodiment of the anti-theft device of the present invention;

FIG. 18 is a right-side elevational view of the anti-theft device shown in FIG. 17;

FIG. 19 is a left-side elevational view of the anti-theft device shown in FIG. 17;

FIG. 20 is a rear elevational view of the anti-theft device shown in FIG. 17;

FIG. 21 is a partial perspective view of a sixth preferred embodiment of the anti-theft device of the present invention;

FIG. 22 is a partial perspective view of a seventh preferred embodiment of the anti-theft device of the present invention;

FIG. 23 is a partial perspective view of an eighth preferred embodiment of the anti-theft device of the present invention;

FIG. 24 is a partial perspective view of a ninth preferred embodiment of the anti-theft device of the present invention;

FIG. 25 is a right-side elevational view of the anti-theft device shown in FIG. 24;

FIG. 26 is a left-side elevational view of the anti-theft device shown in FIG. 24;

FIG. 27 is a front elevational view of the anti-theft device shown in FIG. 24;

FIG. 28 is a rear elevational view of the anti-theft device shown in FIG. 24;

FIG. 28A is a bottom plan view of the anti-theft device shown in FIG. 24;

FIG. 29 is a bottom plan view of a handle in accordance with a tenth preferred embodiment of the anti-theft device of the present invention;

FIG. 30 is a side elevational view of the handle shown in FIG. 29, attached to a serrated rod;

FIG. 31 is a greatly enlarged cross-sectional view of the handle shown in FIG. 30 taken along line 31-31 of FIG. 30;

FIG. 32 is a partially exploded perspective view of a rod and pin connection in accordance with an eleventh preferred embodiment of the anti-theft device of the present invention;

FIG. 33 is a partially exploded front elevational of a rod and pin connection in accordance with a twelfth preferred embodiment of the anti-theft device of the present invention;

FIG. 34 is an enlarged left elevational view of the anti-theft device shown in FIG. 33;

FIG. 35 is a front elevational view of a locking mechanism in accordance with a thirteenth preferred embodiment of the anti-theft device of the present invention;

FIG. 36 is a greatly enlarged perspective view of the locking pin shown in FIG. 35;

FIG. 37 is a partial perspective view of a base in accordance with a fourteenth preferred embodiment of the anti-theft device of the present invention;

FIG. 38 is a top plan view of the anti-theft device shown in FIG. 37;

FIG. 39 is a front elevational view of the anti-theft device shown in FIG. 37.

FIG. 40 is a partial perspective view of an anti-theft device in accordance with a fifteenth preferred embodiment of the present invention;

FIG. 41 is a greatly enlarged fragmentary view of a portion of the anti-theft device shown in FIG. 40;

FIG. 42 is a front elevational view of the anti-theft device shown in FIG. 40;

FIG. 43 is a right-side elevational view of the anti-theft device shown in FIG. 40;

FIG. 44 is a top plan view of the anti-theft device shown in FIG. 40;

FIG. 45 is a partial perspective view of an anti-theft device in accordance with a sixteenth preferred embodiment of the present invention;

FIG. 46 is a greatly enlarged fragmentary view of a portion of the anti-theft device shown in FIG. 45.

FIG. 47 is a front elevational view of the anti-theft device shown in FIG. 45;

FIG. 48 is a right-side elevational view of the anti-theft device shown in FIG. 45;

FIG. 49 is a top plan view of the anti-theft device shown in FIG. 45;

FIG. 50 is a partial perspective view of an anti-theft device in accordance with an seventeenth embodiment of the present invention;

FIG. 51 is a partial front elevational view of the anti-theft device shown in FIG. 50;

FIG. 52 is a right-side elevational view of the anti-theft device shown in FIG. 50;

FIG. 53 is a top plan view, partially in cross section, of the anti-theft device shown in FIG. 50;

FIG. 54 is a partial perspective view of an anti-theft device in accordance with a eighteenth embodiment of the present invention;

FIG. 55 is a partial front elevational view of the anti-theft device shown in FIG. 54;

FIG. 56 is a right-side elevational view of the anti-theft device shown in FIG. 54;

FIG. 57 is a top plan view, partially in cross-section, of the anti-theft device shown in FIG. 54;

FIG. 58 is a partial perspective view of a second anti-theft device in accordance with an nineteenth embodiment of the present invention;

FIG. 59 is a front elevational view of the anti-theft device shown in FIG. 58;

FIG. 60 is a right-side elevational view of the anti-theft device shown in FIG. 58;

FIG. 61 is a top plan view, partially in cross section, of the anti-theft device shown in FIG. 58;

FIG. 62 is a partial perspective view of an anti-theft device in accordance with a twentieth embodiment of the present invention; and

FIG. 63 is a partial perspective view of an anti-theft device shown accordance with a twenty first embodiment of the present invention.

### DETAILED DESCRIPTION OF THE PREFERRED EMBODIMENT

The brake anti-theft device of the present invention is now described with reference to the enclosed Figures wherein the same numbers are utilized where applicable. In general, the present invention is a device specifically designed to lock the brake pedal or clutch pedal of a motor vehicle in an up, i.e., non-depressed, state.

Since 1990, many vehicles manufactured for sale in North America cannot start unless the brake pedal of the vehicle is depressed. In vehicles with automatic-shifting transmissions, this feature is referred to as a “brake pedal shift interlock” or BPSI. Many non-automatic transmission, or “standard transmission” vehicles, have a similar feature called the clutch pedal start interlock or CPSI, which requires that the clutch pedal be depressed before the vehicle can start. The present invention is applicable to both types of vehicles. In essence, the invention is specifically designed to take advantage of the BPSI or CPSI by preventing the brake pedal of any vehicle, or the clutch pedal of a standard-transmission vehicle, from being operably depressed, i.e. depressed sufficiently to disable the CPSI or BPSI to thereby precluding starting and/or driving of the vehicle. The present invention is also designed to work on vehicles not having BPSI or CPSI, discounting theft merely by preventing the brake or clutch pedal from being operably depressed, thereby preventing the vehicle from being normally braked or its transmission shifted, respectively.

A particular feature of the present invention is that it is intended to be utilized by the driver or operator from the comfort of the driver's seat of the vehicle without any need for the driver to get down on his or her hands or knees or to crouch in order to install or adjust the device. While the present invention will be described in the context of a conventional automobile it is to be appreciated that the teachings of the present invention are equally applicable to all manner of vehicles having brake pedal or clutch pedal arms or shafts including sport utility vehicles, vans, pick-up trucks and heavy trucks.

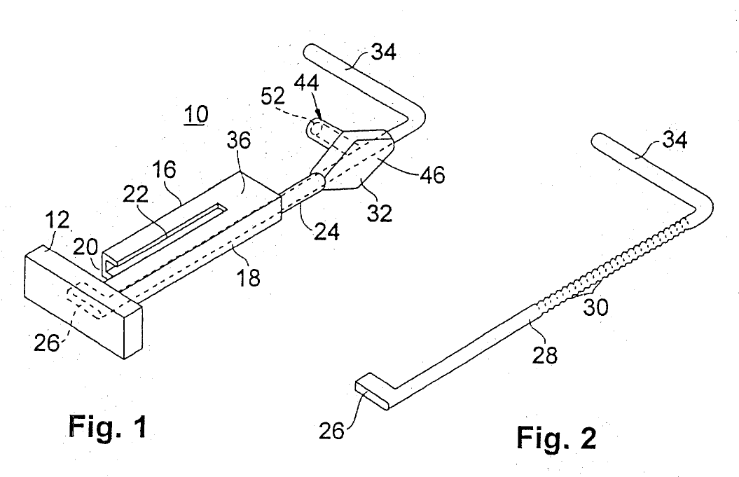

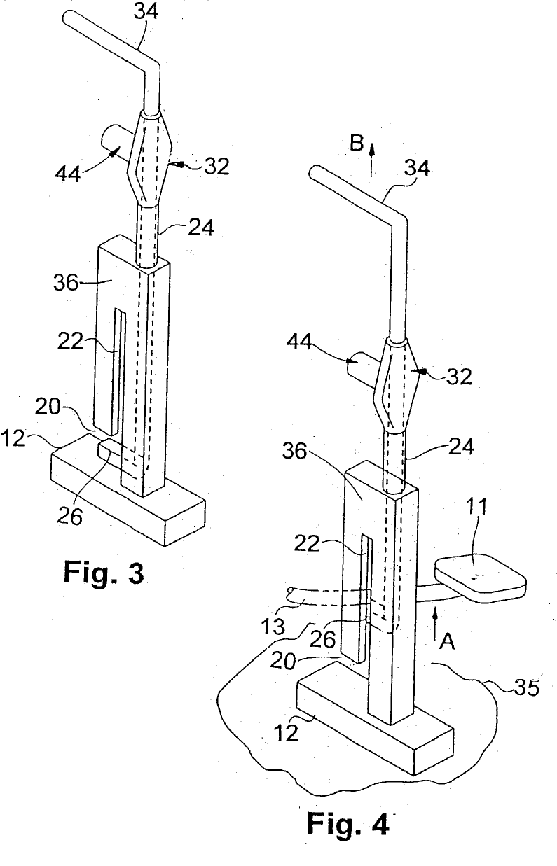

For purposes of explanation the present invention is now described in the context of a device which locks a brake pedal in an upward position, thus, for example, disabling the BPSI of the vehicle. Referring now to FIGS. 1 to 4, there is shown a first preferred embodiment of the brake or clutch lock anti-theft device 10 of the present invention having a base 12 which is configured for stable placement on the floor of the vehicle adjacent to, i.e., beneath, the brake pedal 11 and shaft 13 supporting the pedal 11. Use of a brake pedal 11 and shaft 13 is intended to be illustrative of the application of the present invention to either a brake pedal 11 or a clutch pedal (not shown) and is not intended to be limiting. The base 12 is configured to be placed flush to the floor of the vehicle directly below the brake pedal and pedal shaft 13 for stable support of the device 10

Extending from the base 12 is a generally U-shaped housing 14. The U-shaped housing includes a second leg 18 attached to the base 12, a first leg 16 shorter than the second leg 18, and a cross member 36 connecting the first and second legs 16, 18 to define a gap or opening 20 between the first leg 16 and the base 12 and a slot 22 between the first and second legs 16, 18. The opening 20 facilitates the placement and removal of the brake pedal shaft 13. In a preferred embodiment, the slot 22 should have an approximate width of the pedal shaft 13 such that the pedal shaft 13 extends through the slot 22 and up to an extended position. In other words, the opening 20 and slot 22 are sufficiently large to receive the brake pedal shaft 13 and permit travel of the pedal shaft 13 through the slot 22. In the extended position, the brake pedal 11 can be depressed freely as it extends downward through the slot 22.

The invention further comprises a locking mechanism indicated generally at 32 associated with a second leg 18 of the U-shaped housing. The locking mechanism includes a lock 44 with a lock housing 46 containing a lock cylinder 52. Extending between the second leg 18 of the U-shaped housing 14 and the lock 44 is a cylindrical tube 24. The second leg 18, the cylindrical tube 24, and the lock housing 46 are preferably a unitary assembly constructed from individual parts, preferably welded together. It will be recognized by those of ordinary skill in the art that the cylindrical tube 24 need not be cylindrical, but may be any hollow structural member, including channel stock, box-section stock, etc. and that the second leg 18 and cylindrical tube 24 can be made from a single piece (not shown).

The locking mechanism 32 also includes a slidable locking pin 26, which is provided at a first end of a rod 28 which passes through the cylindrical tube 24, second leg 18 and the lock housing 46. The rod 28 also includes lock ratchets or serrations 30 preferably machined along the mid-section of the rod 28 to at least a point where the serrations 30 pass through the lock housing 46 between both the raised and lowered or retracted positions of the locking pin 26. The second end of the rod 28 preferably comprises a handle 34 which is used to pull the rod 28 upward or push the rod 28 downward relative to the base 12. The preferred locking mechanism 32 which is utilized in the present invention may include a commercially available key operated steering wheel lock cylinder including a movable latch member, which can be releasably engaged with the serrations 30. Other locks are contemplated for the present invention including combination locks.

The locking mechanism 32 has both an unlocked state and a locked state. In the unlocked state, the rod 28 is free to slide through the lock housing 46. The unlocked state provides for installation and removal of the anti-theft device 10 by permitting the rod 28 to be positioned (i.e., retracted) such that the locking pin 26 does not obscure the opening 20 or slot 22. Preferably the locking pin 26 is fully received by the base 12 during installation and removal of the device 10 but it will be appreciated that full retraction of the pin 26 will not always be required and that only partial retraction as shown in some later figures may be sufficient. In the locked state, the lock 44 locks the ratchets 30 at the appropriate point as discussed more fully below. As shown most clearly in FIG. 4, as the rod 28 is moved in an upward direction, away from the base 12, the locking pin 26 enters the slot 22 and moves upwardly (Arrow A), thus securing the bottom of the pedal shaft 13 in an upward or unextended or inoperable position so that the pedal 11 cannot be operably depressed. Because the pedal 11 cannot be operably depressed, the car cannot be placed in gear in vehicles containing BPSI, cannot be started in vehicles with CPSI, and in vehicles with and without BPSI or CPSI, cannot be driven normally as either the brake or clutch pedal 11 cannot be depressed to brake the vehicle or shift a standard transmission.

In the present description, several preferred embodiments will be discussed. Each later-described preferred embodiment of the anti-theft device 10 has the same basic features as the previous preferred embodiments, so only particular additional or modified features as will be discussed. Accordingly, descriptions of the features of the latter-described preferred embodiments that are the same as those of the earlier-described preferred embodiments are not repeated. Instead, identical elements have been given identical element numerals throughout and only the differences between the earlier-described preferred embodiments and the latter-described preferred embodiment will be described, with numerals incremented by hundreds being used for new or revised features of like elements.

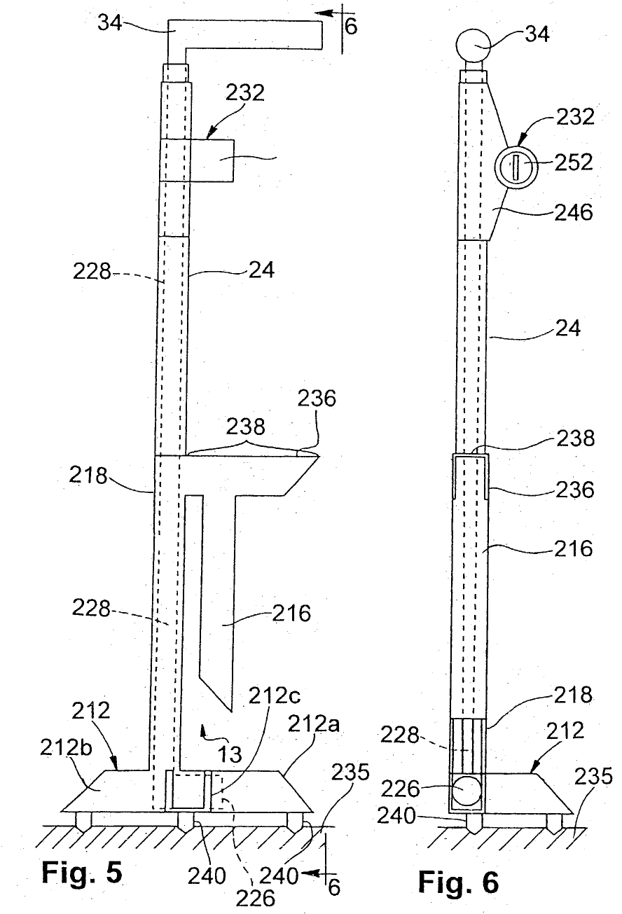

A second preferred embodiment 210 of the present invention is shown in FIGS. 5 and 6. As shown in FIG. 5, the base 212 has three leg portions 212a, 212b, and 212c, configured in a generally T-shaped pattern. The advantage of a T-shaped pattern is that it provides greater stability and maximum strength and support to the anti-theft device 210 when installed, in addition to reduced weight, in comparison to the solid rectangular base 12. The outboard ends of the leg portions 212a, 212b, 212c and the bottom of the first leg 216 suggestedly are beveled preferably at 45 degree angles, so that the pedal shaft 13 can more easily be guided into and out of the slot 22 when the device is installed and removed from the pedal shaft 13.

The second preferred embodiment 210 further incorporates an elongated cross member 236 for enabling the driver to press the device into the floorboard or carpet of the vehicle. The elongated cross member 236 extends horizontally from the top of the first leg 216, thus providing a sufficient surface area 238 for the foot of an operator to press downward. It is contemplated that the surface area 238 could include a gripping top surface.

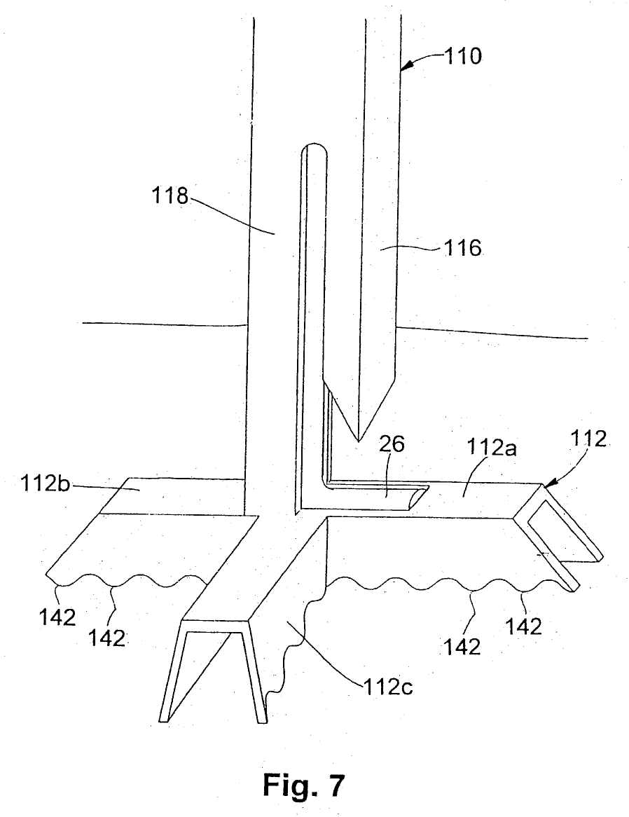

The second preferred embodiment 210 further incorporates studs 240 which extend downward from the base 212 and which facilitate the positioning and retention of the device 210 against a floor particularly a carpeted floor 235 in the vehicle. The studs 240 prevent the device 210 from moving with respect to the floor. As shown in FIG. 7, a device 110 may also incorporate cleats 142 which are cut into or otherwise provided in the bottom of the base 12. It is contemplated that a combination of studs 240 and cleats 142 could be used without departing from the scope and spirit of the invention. Lock housing 246 is smaller than housing 46 and hangs the lock cylinder across rod 28.

The operation of the present invention is now described with reference to the enclosed figures and most particularly FIGS. 1 through 4. The driver or operator desiring to utilize the device 10 (110 or 210) unlocks the device and lowers the pin 26 all the way down to the base 12 (112, 212) by grasping the handle 34 and pushing the handle 34 toward the base 12 (112, 212). The base 12 (112, 212) is then placed on the floor 35 beneath the pedal shaft 13 which is located generally beneath the steering wheel and steering column (neither shown in FIGS. 1-6). The pedal shaft 13, is then passed through the opening 20 in the U-shaped housing 14 (214) and into the slot 22 with the base 12 (112, 212) positioned squarely on the floor 35 of the vehicle. The operator then pulls the handle 34 upwardly (Arrow A in FIG. 4), thus raising the locking pin 26 upward into the slot 22 and securing the bottom of the pedal shaft 13 so as to lock the brake (or clutch) pedal 11, as appropriate, is in an upward position. As is shown in FIGS. 5 and 6, the operator can place his foot on the surface area 238 of an elongated cross member 236, if provided, to maximize the downward thrust of the device 210 against the floor 35 of the vehicle. If provided, the cleats 142 and/or the studs 240 secure the device against the carpet or other surface of the floor 35 beneath pedal 11. The vehicle operator then locks the device 10 (110, 210) in this position using the lock mechanism 32 (232) such that the pedal 11 cannot be depressed, thereby disabling the operation of the vehicle.

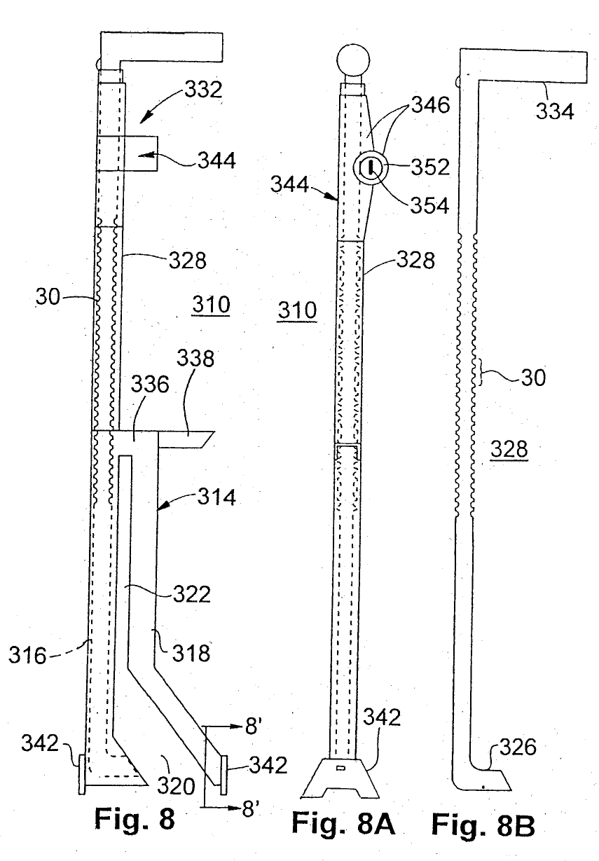

FIGS. 8-8B illustrate a third preferred embodiment device 310 of the present invention. In this embodiment, the first and second legs 316, 318 are of substantially equal height and thus eliminate the need for a base as shown and described with respect to the first and second preferred embodiments. The first and second legs 316, 318 are spaced at the bottom to form an opening 320 which is tapered to slide over the pedal shaft 13, permitting the pedal shaft 13 to enter the slot 322, which begins at the narrow end of opening 320. The locking pin 326 is pulled upward by rod 328 thereby locking the pedal 11 and shaft 13 in an upward position as in the other embodiments described herein. The third preferred embodiment 310 further includes two rotatable feet 342, which are attached to the bottom of the first and second legs 316, 318 and which facilitate the pivotable support and positioning of the device 310. The main attribute of this embodiment is to facilitate ease of placement of the device 310.

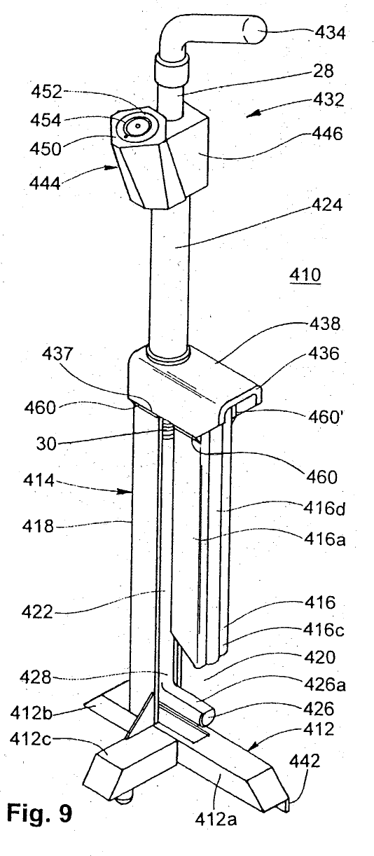

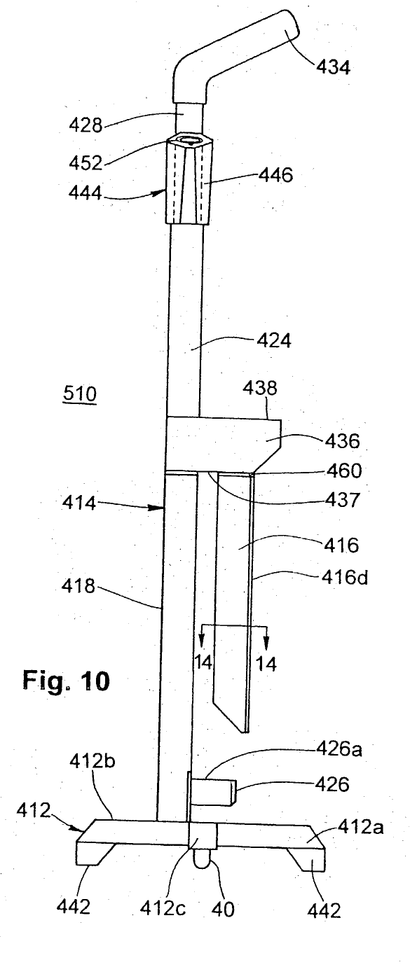

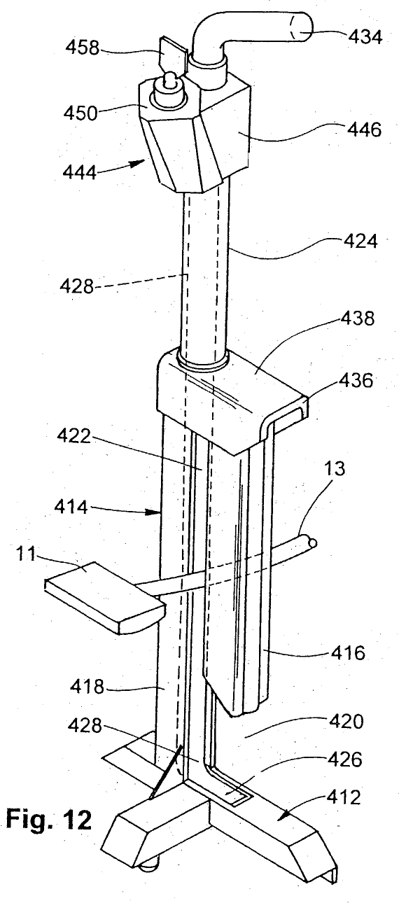

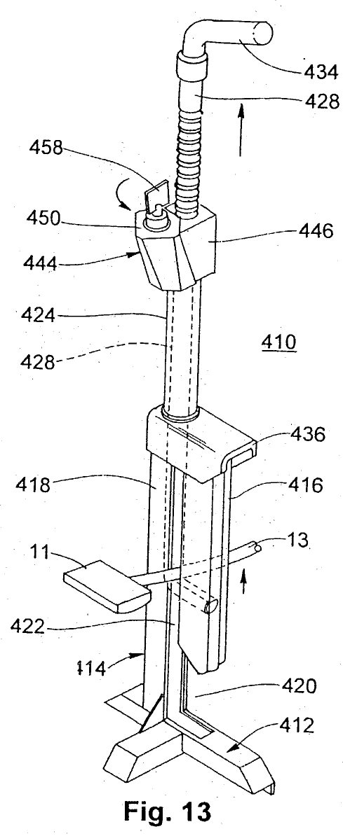

Referring now to FIGS. 9-13, there is shown an anti-theft device 410 in accordance with a fourth preferred embodiment of the present invention. The locking mechanism 432 of the fourth preferred embodiment includes a locking pin 426 and a lock 444. As with the previously-described preferred embodiments, the locking pin 426 is at one end of an elongated rod or shaft 428 (see FIG. 15) movable through the second leg 418 of the U-shaped housing 414 and the cylindrical housing 24. The locking pin 426 is selectively movable on the U-shaped housing 414 between a raised position shown in FIG. 13 and a retracted position shown in FIG. 12. In the raised position, the locking pin 426 is sufficiently close to a lower side of the pedal shaft 13 to prevent the pedal shaft 13 from being operably depressed, that is depressed sufficiently to enable the vehicle to be started and/or normally controlled. In the retracted position, the locking pin 426 permits travel of the pedal shaft 13 through the slot 22 and opening 20. The locking pin 426 of the fourth preferred embodiment 410 embodies a significant improvement over the designs of the first through third preferred embodiments in that the upper, pedal shaft contacting surface 426a of the locking pin 426 is generally flat in a direction facing the pedal shaft 13. By providing a flattened shaft contact surface 426a, a larger contact region between the locking pin 426 and the pedal shaft 13 is created, thereby resulting in a more secure installation of the anti-theft device 410.

On the opposing end of the rod 428 from the locking pin 426 is a handle 434, which differs from previous handles 34, 234, 334 of the first through third preferred embodiments in several ways. First, the handle 434 is preferably threaded onto the rod 428. This is an improvement in security over prior designs, like embodiment 10, where an adhesive method of securing a smooth bored handle 34 to the end of a smooth rod 28 was employed. It is also contemplated that the handle 434 could be further attached to the rod 428 by welding, brazing, or the like, such that a secure, unitary structure is created preventing the unthreading of the handle 434 from rod 428. Second, the handle 434 is attached to the rod 428 at a non-perpendicular angle to the rod 428. This design presents a great advance in security over prior designs in that where the handle 34 and rod 28 are joined in a perpendicular angle, a thief may use a hammer to strike the handle 34 in an effort to break the lock 44. Because the handle 34 was perpendicular to the rod 28, a direct blow to the handle 34 was readily achievable and the entire force of the blow would be transmitted through the rod 28 to the lock 44, thereby defeating the lock 44. However, where handle 434 is at a non-perpendicular angle to the rod 428, a thief cannot achieve a direct blow to the handle 434 or the top of the rod, parallel to the rod, as the handle 434 will deflect at least a portion of the force of the blow. More preferably, the upper surface of handle 434 is smoothly curved and extends away from the base 414 in a generally convex shape to further deflect impacts from directly above the rod 428. Third, the handle 434 is made in one smooth piece without seams and with a smoothly varying, creaseless. seamless outer surface above rod 428, which does not have any edges to be engaged by a tool (e.g. chisel, saw or drill).

Lock 444 is integrated into and is coupled to the U-shaped housing 414 through cylindrical tube 424. Lock 444 includes a cylinder 452 with the operative mechanical components in a housing or head 454. The lock 444 is operatively connected to the locking pin 426 to fix the locking pin 426 in at least the raised position through engagement of the lock 444 and the serrations 30 of the rod 428. The lock 444 has an upper face 450 with a key opening 454. The lock 444 is preferably a barrel type with a circular key opening 454 accepting a cylindrically shaped, barrel-type key 458 for greatly increased security in comparison to standard blank-type (flat) keys (not shown). Barrel-type key locks are particularly resistant to being picked and to being broken with slide hammers. A sheet metal screw attachment is commonly fitted to the end of a slide hammer and is easily screwed into locks that accept blank-type (flat) keys. The slide hammer is then used to pull the lock cylinder from its housing, thus defeating the security device. It is much more difficult for one to use this technique to defeat a lock having a circular key opening 454 and barrel-type key 458 as the sheet-metal screw attachment cannot readily be attached to such a lock.

Lock housing 446 extends from the top of cylindrical member 424 in the direction of base leg portion 412c towards the operator seated in front of the device 410. The upper face 450 of the lock 444 and lock cylinder 452 faces substantially oppositely away from the base 412. Preferably the upper face 450 is pitched at an angle which is transverse (i.e. non-perpendicular and non-parallel) to a support plane defined by the bottom of the base 412 (or more particularly, the bottoms of stud 440 and cleats 442). The face is pitched downwardly from the plane of the base suggestedly at an angle of between about 15 and 30 degrees, more particularly between about 20 and 25 degrees. Orientation of the upper face 450, and hence the cylinder 452 in a direction substantially oppositely away from the base 412 obviates problems encountered with previous locking anti-theft mechanisms where the locks faced in a lateral direction (i.e., the first three embodiments). In using those previous designs, if for example the lock faced leftwardly and the operator was right handed, the operator had to use his or her off-hand to operate the lock to fix the anti-theft device. The orientation of the upper face 450 of the lock 444 of the fourth preferred embodiment 410 solves this problem by enabling the operator to use his or her dominant hand to fix the device 410 to the vehicle. Additionally, orientation of the upper face 450 in a direction substantially oppositely away from the base 412 provides additional security with respect to cutting through the lock housing 446 with a saw. In prior designs like the first three embodiments, where the lock housing 50 positioned the lock cylinder 52 in a direction perpendicular to the rod 28, the side of the lock housing 46 surrounding the lock cylinder 52 could readily be engaged by a hacksaw, thereby permitting one to cut through the lock 44 to defeat the device 10. Directing the upper face 450 oppositely away from the base 412 eliminates any substantial upper surface to which one can engage a hacksaw and further serves to deflect blows delivered from above the device 410.

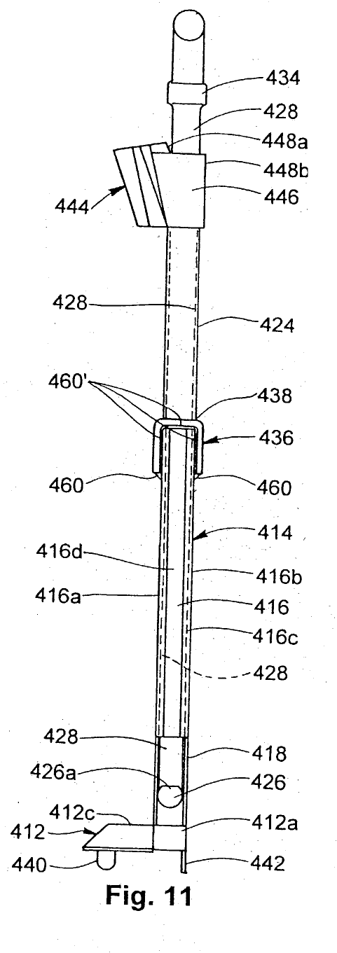

In the same vein, the lock cylinder 452 is protected by the lock housing 446, which surrounds the lock cylinder 452. The lock housing 446 preferably has more than four lateral sides. For example, eight lateral sides are depicted forming the perimeter of the upper face 450 in FIG. 9. Only the side 438a closest to rod 28 (FIG. 11) is rectangular. The remaining seven lateral sides surrounding upper face 450 are triangular or trapezoidal. The only other rectangular lateral side is side 438b (also FIG. 11). By providing more than four lateral sides 448, and particularly non-rectangular sides, one is presented with great difficulty in perpendicularly engaging the intersection of the upper face 450 and the lateral sides 448 or any of the lateral sides 448 directly with a hacksaw. A perpendicular engagement between a hacksaw blade (not shown) and the surface intended to be cut is optimal for efficient cutting.

Suggestedly, lock 444 includes a separate latch member in housing 446 which engages the serrations 30 of the rod 428 to secure the rod 428 and locking pin 426. The latch preferably is spring loaded into engagement with the serrations and is disengaged only by rotation of the inner member of the cylinder 452 turned by key 458. Thus, the latch is not part of the cylinder but the cylinder 452 is need to disengage the latch. Therefore, destruction of the cylinder 452, for example by drilling it out, will not release the latch. The internal latch is further protected from attempting to freeze the cylinder to shrink it.

To further enhance the security of the lock 444, the lock housing 446 is made from a tough material to prevent the lock 444 from readily being defeated by cutting or impact, preferably hardened steel. To further increase security of the present invention, the legs 416, 418 and cross member 436 of the generally U-shaped housing 414 and cylindrical tube 424 of the fourth preferred embodiment device 410 are also made from similarly tough material, preferably hardened steel. While it is contemplated that other tough metals (e.g., stainless steel) could be employed without departing from the scope and spirit of the invention, hardened steel provides an optimal balance between high strength and thus security and expense.

As discussed above, the first leg 416 and second leg 418 of the U-shaped housing 414 are connected by cross member 436. In the fourth preferred embodiment 410, the cross member 436 overlaps each of the first and second legs 416, 418 and presents lower edges 437 of the cross member 436 overlapping the legs 416, 418 and which are welded to the upper sides of the first and second legs 416, 418 by welds 460 best seen in FIGS. 9-11. By overlapping the cross member 436 with the first and second legs 416, 418, rigidity of the first and second legs 416, 418 and the U-shaped housing 414 is increased. Accordingly, security of the anti-theft device 410 is greatly increased. As shown in FIGS. 9 and 11, it is also preferred that the cross member 436 be welded at 460 to the first leg 416 along the horizontal and two vertical interior intersections of those two members to further increase structural integrity of the anti-theft device 410 and prevent the removal of the first leg 416 from the housing 414. Cross member 436 preferably extends fully across second leg 418 and rod 428 is passed through the cross member 436 to deter disassembly of housing 414.

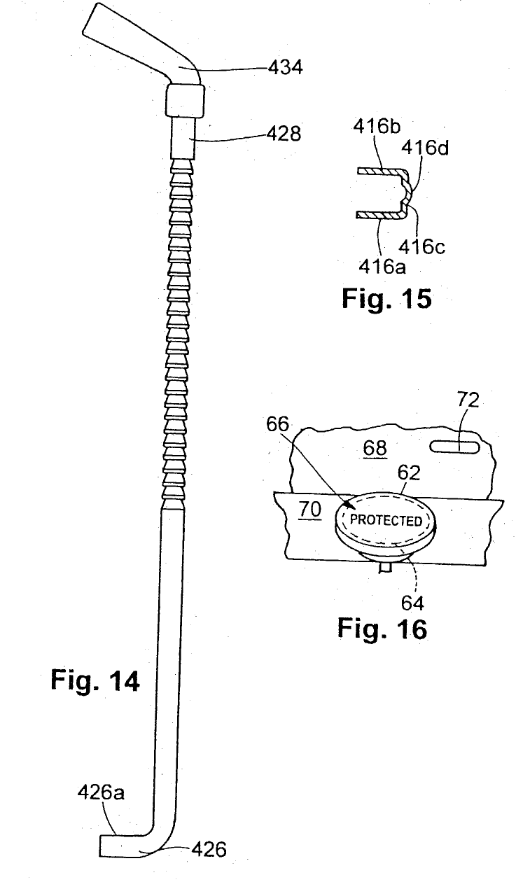

It is suggested that at least one of the first and second legs 416, 418 be modified from ordinary channel stock. Referring to FIG. 14, preferably first leg 416 is a generally U-shaped member (when viewed in axial cross section) with opposing parallel arms 416a, 416b joined by a cross wall 416c. Preferably, the cross wall 416c has a deflection, preferably an outward bow 416d between the pair of arms 416a, 416b, for increased longitudinal stiffness of the leg 416 (and/or 418) with respect to ordinary channel stock. Forming at least one of the first and second legs 416, 418 as a generally U-shaped member like member 416 with bowed or otherwise stiffened cross wall overcomes a significant drawback of prior designs that employed simple channel stock of three straight, perpendicular walls to form the first and second legs 16, 18. The longitudinal stiffness of straight sided channel stock is significantly lower than that of the U-shaped configuration with a deflected cross wall 416c. It is correspondingly easier to defeat a security device having first and second legs 16, 18 made from simple channel stock simply by bending the first leg 16 such that the pedal shaft 13 can be removed from the slot 22 between the pin 26 and the bent leg 16. It is also contemplated that other cross sectional shapes of the leg 416 and of the walls 416a, 416b and/or 416c in particular could be used to form the first or first and second legs 416, 418 for increased strength without departing from the spirit and scope of the present invention.

FIG. 15 depicts rod 428 with serrations 30, locking pin 426 and handle 434. Preferably the rod 428 and pin 426 are formed from a single piece of hardened steel. As mentioned earlier, handle 434 is separately formed from a single piece of tough material, preferably forges from hardened steel, and threaded onto rod 428.

Any of the anti-theft devices 10, 210, 310, 410 can be combined with a banner configured for attachment to the vehicle to announce the use of the device. As shown in FIG. 16, the banner 62 preferably is a cover configured for attachment to the steering wheel 64 of the vehicle. The banner 62 preferably has a logo 64 or other identifying indicia to inform would-be thieves that the vehicle is immobilized through use of the anti-theft device 10, 210, 310, 410. In this way, notwithstanding that the anti-theft device is not readily visible because it is used below the steering wheel and dashboard in the leg compartment of the vehicle, a would-be thief would likely not forcibly enter the vehicle only to discover after having caused substantial damage to the vehicle that his or her efforts would be futile. The banner need not be attached to the steering wheel 64 of the vehicle, but can be configured to be mounted in any visible location, such as on the interior surface of the windshield 68 or another window, on the dashboard 70, or hanging from a rearview mirror 72.

It is to be appreciated by those skilled in the art that the device of the present invention may include a protective outer coating composed of vinyl, PTFE, rubber or plastic.

The following is a description of the fifth through twenty-first embodiments of the present invention. The subsequent embodiments are improvements or variations to the embodiments described above. The following describes the new features of the fifth through twenty-first embodiments without a detailed discussion of the elements previously described above for purposes of convenience and brevity only and shall not be limiting.

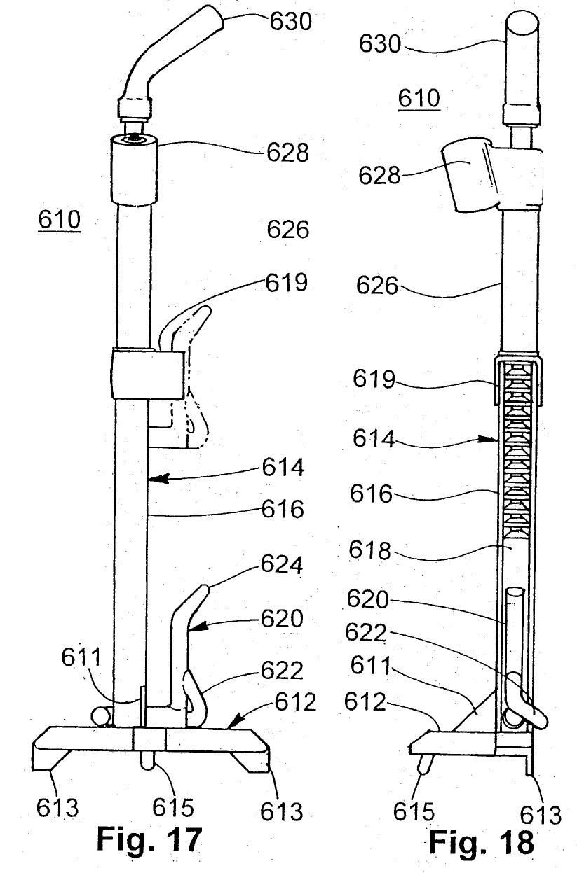

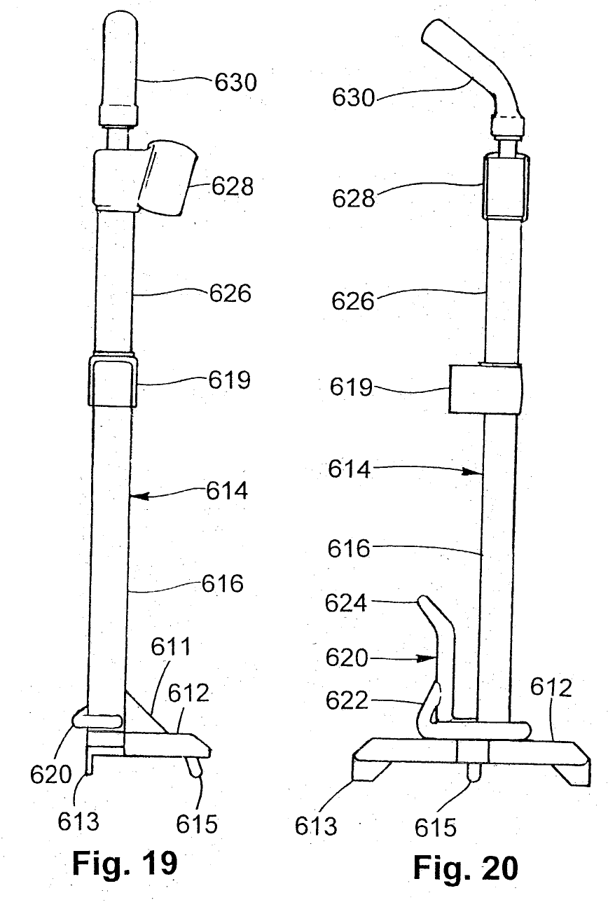

Referring now to FIGS. 17-20, there is shown an anti-theft device 610 in accordance with a fifth embodiment of the present invention. As with the previously-described preferred embodiments, the device 610 comprises a base 612 for placement on a floor of a vehicle and a housing 614 having an arm 616 attached to the base 612. The base may also incorporate cleats 613 and studs 615, which are cut into or otherwise provided in the bottom of the base 612. It is contemplated that a combination of studs 615 and cleats 613 will be used to secure the device against the carpet or other surface of the vehicle floor board. Additionally, a generally triangularly shaped gusset 611 may extend between the base 612 and the arm 616 to give the device 610 additional strength and resistance to tampering.

The housing 614 preferably includes a cross member 619 extending generally perpendicularly from the arm 616 for receiving a foot of a user (not shown) to firmly plant the base 612 into the carpet of the vehicle floor board. A rod 618 is disposed within an opening in the housing 614, and one end of the rod 618 has a generally J-shaped end 620 for receiving the brake or clutch pedal shaft (not shown in FIGS. 17-20). The rod 618 is slidable within the arm 616 so that the J-shaped end 620 is movable between a raised position and a retracted position, the raised position being shown in phantom in FIG. 17 and the retracted position being shown in solid lines in FIGS. 17-20. In the retracted position, the J-shaped end 620 is spaced from the pedal shaft, thus permitting the pedal shaft to be inserted into the J-shaped end 620 and secured therein. In the raised position the J-shaped end secures the pedal shaft and prevents the pedal shaft from being operably depressed, i.e., depressed sufficiently to enable the vehicle to be started and/or normally controlled.

Preferably, the J-shaped end 620 has a terminal tip portion 624 that extends at an acute angle with respect to the rod 618 to facilitate positioning the pedal shaft within the J-shaped end 620. It is also preferred that the J-shaped end 620 further includes a reinforcing buttress 622 extending between the rod 618 and the J-shaped end 620 to give the J-shaped end 620 additional structural integrity so as to prevent an unauthorized user from attempting to pry the J-shaped end 620 in a direction away from the housing 614 in order to release the pedal shaft from the J-shaped end 620. If desired, a gusset (not shown) may extend between the J-shaped end 620 and the reinforcing buttress 622 to provide additional strength to the reinforcing buttress 622. The J-shaped end 620 can be formed by welding a metal piece in the form of a J-shape to the rod 618. Alternatively, the J-shaped end 620 may be cast in a mold in one piece from a molten metal.

Additionally, in the fifth embodiment the rod 618 extends upward through a cylindrical member 626, and a locking mechanism (not shown) located in the lock housing 628 is operably connected to the rod 618 in order to fix the J-shaped end 620 in (at least) the raised position. A handle 630 facilitates the use of the device 610.

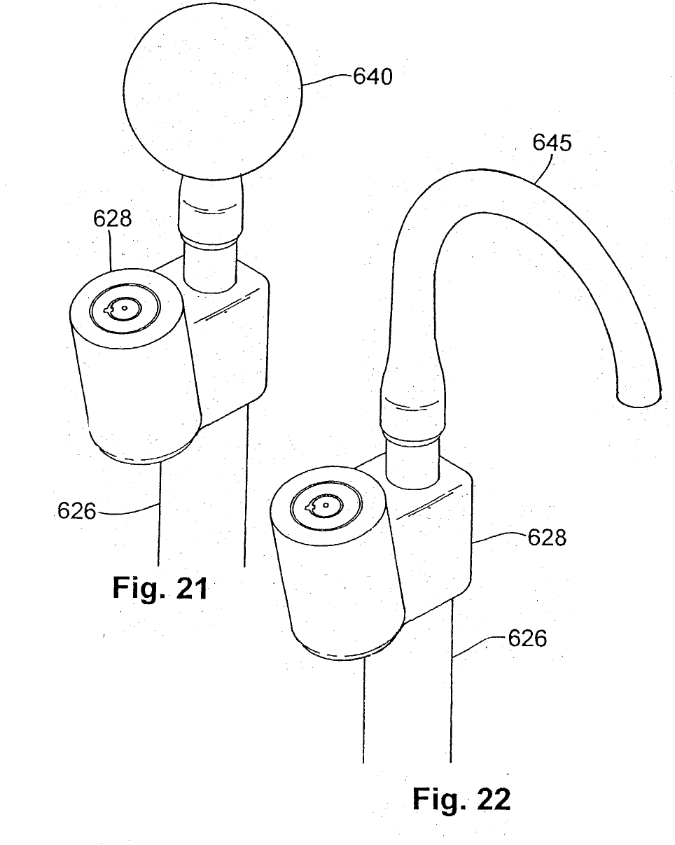

A sixth and seventh embodiment for use with any of the previously disclosed or any of the subsequently discussed embodiments of the anti-theft device is shown in FIGS. 21-22, in which each handle has a different shape than previously disclosed. For example, the handle may be in the shape of an ellipsoid, or more specifically, a sphere 640 as shown in FIG. 21. Other suitable shapes also include one sheet hyperboloids, elliptic paraboloids, and elliptic cylinders. The handle may also be in the form of a J-shape 645, as shown in FIG. 22. These differently-shaped handles provide both ornamental and functional benefits. Thus, users of the device may find a sphere-shaped handle more aesthetically pleasing and attractive than other handle shapes. Also, the use of a handle having a J-shape may be functionally beneficial for an elderly or disabled user, to assist them in gripping the handle in order to operate the device.

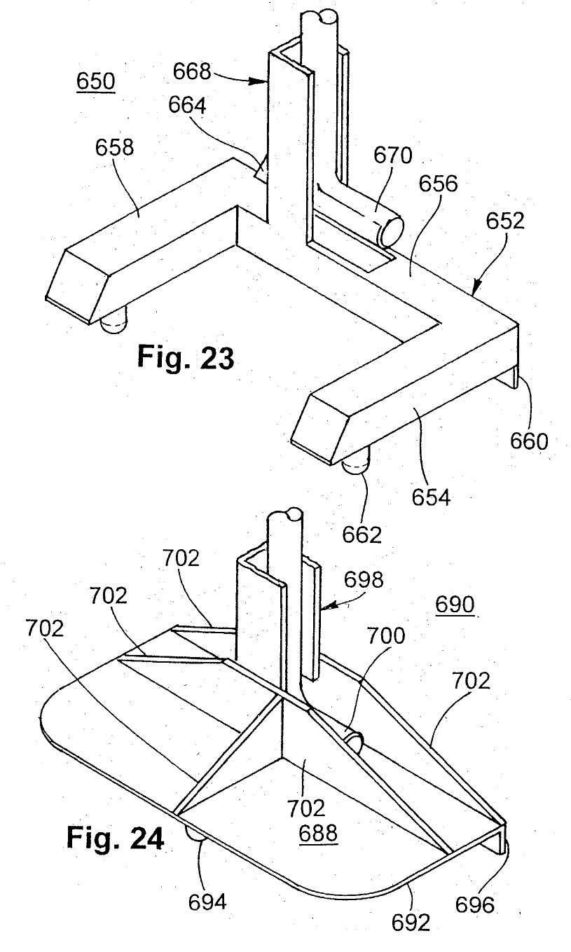

Shown in FIG. 23 is an eighth embodiment of the device 650 having a generally U-shaped base 652 for use with any of the embodiments disclosed herein. The U-shaped base 652 includes a first leg 654, a second leg 658, and a connector piece 656, which preferably is longer than both the first leg 654 and second leg 658, and which connects the first leg 654 to the second leg 658. The U-shaped base 652 may also include cleats 660 and studs 662 to secure the U-shaped base 652 to the floor of the vehicle and at least one gusset 664 to provide further strengthening and reinforcement to the device. As shown in FIG. 23, the U-shaped base 652 is attached to a housing 668, any of the housings shown in the previous embodiments are suitable as the housing 668. Also shown in FIG. 23 is a locking pin 670, selectively movable relative to the housing 668. Not shown is a locking mechanism operably connected to the locking pin to secure the locking pin with respect to the housing and prevent the pedal shaft (not shown in FIG. 23) from being depressed. Additionally, the outboard ends of the first leg 654 and the second leg 658 may be beveled, preferably at a 45 degree angle, so that the pedal shaft can more easily be guided into and out of the device when the device is installed and removed from the pedal shaft. The U-shaped base 658 is physically assembled by welding, as discussed above in connection with the first through fourth embodiments.

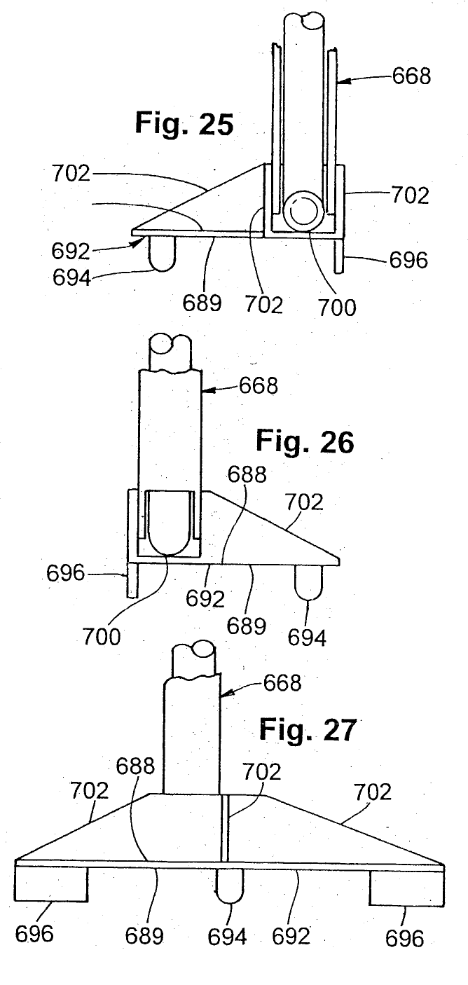

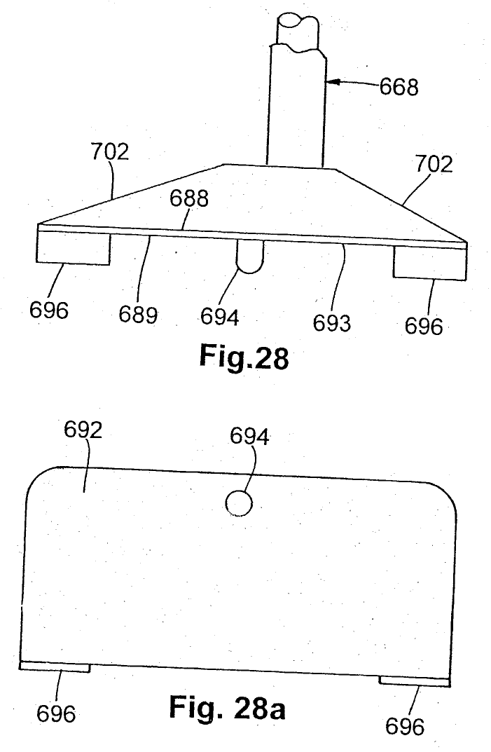

Shown in FIGS. 24-28A is a ninth embodiment an anti-theft device 690 for use with any of the embodiments disclosed herein. In the ninth preferred embodiment, the device 690 includes a generally flat base 692 having a top side 688 parallel to a bottom side 689, which together define the thickness of the base 692. The base 692 preferably includes a combination of two cleats 696 and one stud 694 extending from the base 692 to secure the device 690 against the carpet or other surface of the floor. While the total number of cleats and studs extending from the base 692 is preferably three. The present invention is not limited to any particular number or combination of studs and cleats. The edge of the base 692 may be beveled at a 45 degree angle (not shown).

A housing 668 is attached to the base 692 by a welded gusset arrangement. Extending between the base 692 and the housing 698 are a plurality of gussets 702, 703, 704 in order to provide further reinforcement between the housing 698 and the base 692. More particularly, first and second generally parallel gussets 702, 703 extend on opposite sides of the housing 698 along the longitudinal length of the base 692. A third gusset 705 extends generally perpendicularly from the second gusset 703 generally in alignment with the housing 698. The first, second and third gussets 702, 703, 704 are welded between the base 692 and the housing 698. While it is preferred to use the gusset arrangement shown in FIG. 24, it is understood by those of ordinary skill in the art that other gusset arrangements could be used without departing from the spirit and scope of the invention.

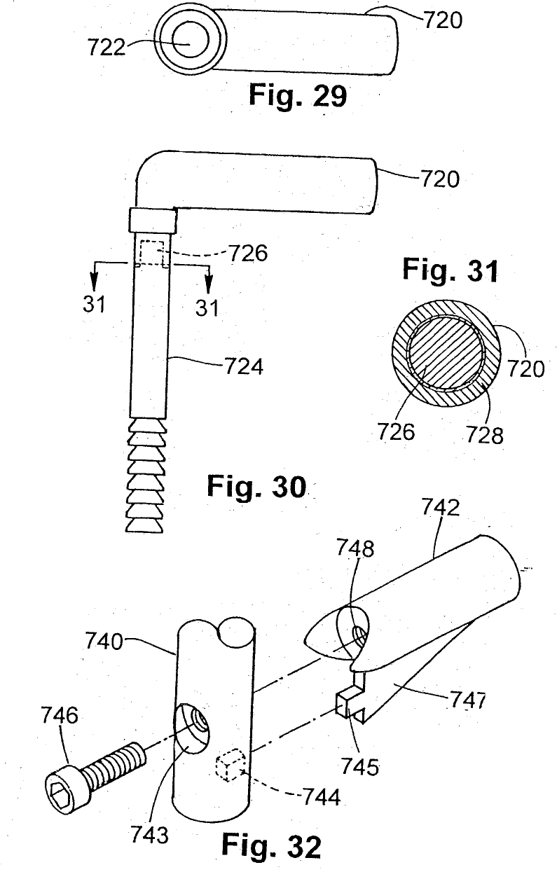

Shown in FIGS. 29-31 is a handle 720 in accordance with a tenth embodiment of the present invention for use with any of the embodiments disclosed herein. FIGS. 29-31 show the second end of a locking pin 724 as a serrated rod and being formed into a dowel 726. The handle 720 has a hole 722 for receiving the dowel 726 and the hole 722 is configured so that a complementary fit is formed between the dowel 726 and the hole 722. Preferably an adhesive material 728 is applied between an exterior surface of the dowel 726 and an interior surface of the hole 722. Connecting the handle to the dowel in this manner allows the rod 724 to be assembled in the housing through the bottom of the base.

The handle configuration and shape shown in FIGS. 29 and 30 are for illustration purposes only. The handle may also be arranged to be at a non-perpendicular angle as shown in FIGS. 9-14, and the handle may have a spherical shape or J-shape as shown in FIGS. 21-22.

Shown in FIG. 32 is a eleventh embodiment of the present invention for use with any of the embodiments disclosed herein, which shows a rod 740 and a locking pin 742. As shown in FIG. 32, the bolt 746 is inserted into and through a complementary bore 743 formed in the rod 740 and into a threaded bore 748 formed in the locking pin 742. Preferably, to provide additional strengthening to the connection between the rod 740 and locking pin 742, a gusset 747 extends between the locking pin 742 and the rod 740. The gusset 747 preferably extends from the bottom of the locking pin 742 to the rod 740. The gusset 747 is preferably formed in a triangular shape and may be formed integrally as one piece with the locking pin 742 or may be welded or otherwise attached to the locking pin 742. The gusset 747 preferably includes a tab 745 that fits within a hole 744 formed inside the rod 740, the hole 744 being configured so that the tab 745 fits snugly inside the hole.

A locking pin 742 which is assembled to the rod 740, as opposed to being integrally formed therewith, allows for easier assembly of the rod 740 within the housing without having to provide an access hole in the base.

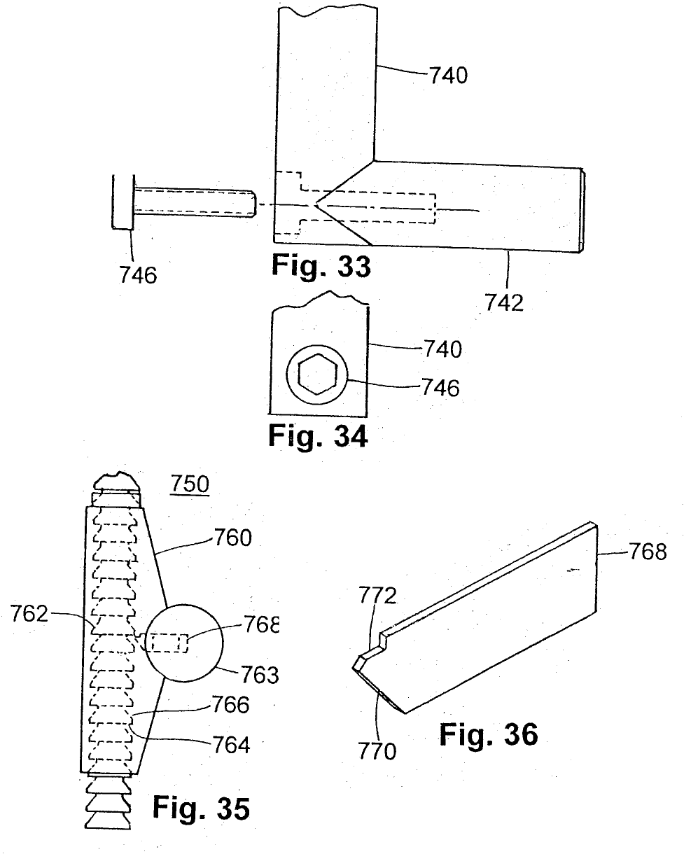

Shown in FIGS. 33-34 is a twelth embodiment of the present invention for use with any of the embodiments disclosed herein, which shows a rod 740 and a locking pin 742. The locking pin 742 is securely fastened to the one end of the rod 740, preferably by a threaded fastener, such as the bolt 746. In the embodiment illustrated in FIGS. 32-33, the bolt 746 is inserted into and through a complementary bore 743 formed in the rod 740. The portion of the rod 740 that is illustrated has a generally cylindrical shape, and one end of the locking pin 742 has a complementary concave surface to permit the locking pin 742 to be smoothly mated to the portion of the rod 740 having a cylindrical shape.

There is shown in FIGS. 35 and 36 a locking mechanism 750 in accordance with a thirteenth embodiment of the present invention. The locking mechanism 750 is for use with any of the embodiments enclosed herein. As shown in FIG. 35, a serrated portion 762 of the rod 761 extends through the lock housing 760. This lock housing 760 is in turn coupled to the housing of any of the previously disclosed anti-theft device embodiments.

Each serration on the serrated portion 762 has a flat, radially-extending surface 764 and a frusto-conical surface 766. Also present is a ratchet pin 768, preferably constructed of tool steel, to engage with the serrated portion 762. Specifically, as shown in FIG. 36, the ratchet pin 768 has a beveled end 770 configured to mate with the frusto-conical surface 766 of the serration, and a notch 772 or a curved portion (not shown) formed upon the beveled end 770 to engage the flat, radially-extending surface 764 of the serration. By forming a curved portion or a notch 772 upon the beveled end, the ratchet pin may be inserted far into the serrated portion 762 so as to increase the portion of the ratchet pin 768 that engages the serrated portion 762 and thus, increases the strength of the interlocking connection formed between the serrated portion 762 and the ratchet pin 768, making it more difficult for an authorized user to adjust the position of the rod 761, upon which the serrated portion 762 is formed.

The operation of this embodiment may be illustrated with specific reference to the first preferred embodiment of the anti-theft device shown in FIGS. 1-4. In operation, a lock 763 in FIG. 35 is coupled to the housing (not shown) and operably connected to the ratchet pin 768 so that when the lock 763 is in the locked position the ratchet pin 768 engages the serration in order to secure the locking pin 26 with respect to the housing (not shown) and prevent the pedal shaft (not shown) from being depressed.

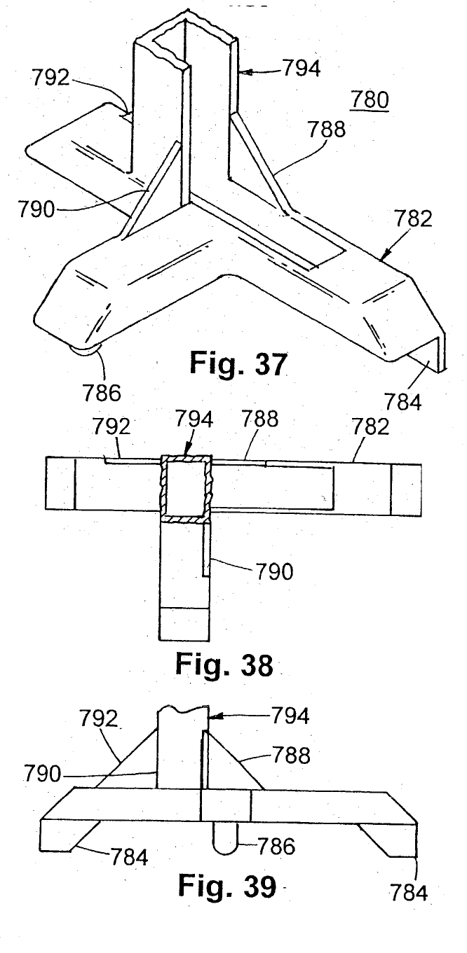

There is shown in FIGS. 37-39, a base 782 in accordance with a fourteenth embodiment of the present invention. The base 782 can be used with any of the embodiments disclosed herein. As shown in FIG. 37, the base 782 is generally T-shaped and is attached to the housing 794. Three gussets 788, 790, 792 each extend between the base 782 and the housing 794 to reinforce the attachment of the housing 794 to the base 782 and thereby prevent a potential unauthorized user of the vehicle to bend the housing 794 relative to the base 782.

The plurality of gussets 788, 790, 792 comprise at least a first gusset 788 and a second gusset 790, with the second gusset 790 arranged generally perpendicular or co-planar (not shown) to the first gusset 788. Preferably, a third gusset 792 is used as well, with the third gusset 792 being arranged generally perpendicular to the second gusset 790. Thus, when the third gusset 792 is present and arranged perpendicularly to the second gusset 790, the third gusset 792 is co-planar with the first gusset 788. The first, second and third gussets 788, 790, 792 are preferably welded to the base 782 in a manner well understood by those of ordinary skill in the art.

Although the base 782 is preferably T-shaped, the base may be formed in a variety of different shapes, such as E-shaped. The T-shaped base 782 may also include cleats 784 and studs 786 to secure the T-shaped base 782 to the floor of the vehicle as described in more detail above. Preferably, a combination of at least three cleats and studs is used.

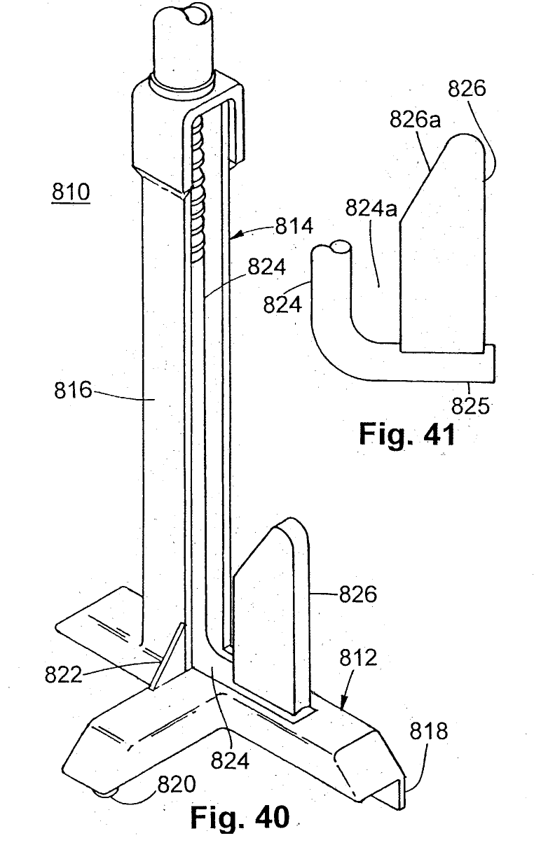

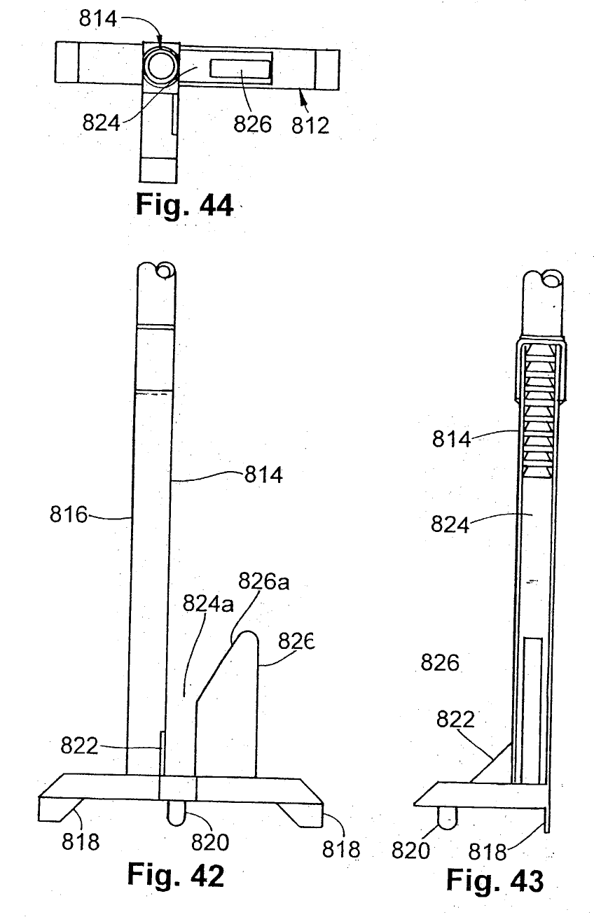

There is shown in FIGS. 40-44 an anti-theft device 810 in accordance with a fifteenth embodiment of the present invention. As with the previously-described preferred embodiments, the device 810 comprises a base 812 for placement on a floor of a vehicle and a housing 814 having an arm 816 attached to the base 812. The base 812 may also incorporate cleats 818 and studs 820, which are cut into or otherwise provided in the bottom of the base 812. It is contemplated that a combination of studs 820 and cleats 818 will be used to secure the device against the carpet or other surface of the vehicle floor board. Additionally, a generally triangularly shaped gusset 822 may extend between the base 812 and the housing 814 to give the device 810 additional strength and resistance to tampering. The housing 814 may include a cross member (not shown) extending generally perpendicularly from the arm 816 for receiving a foot of a user (not shown) to firmly plant the base 812 into the carpet of the vehicle floor board (not shown).

A rod 824, which is preferably partially serrated, is disposed within an opening in the housing 814, and preferably extending from the one end of the rod 824 is a locking pin 825 as illustrated in FIG. 41. A retaining block 826 extends from one end of the rod 824. The retaining block 826 is preferably attached to the rod 824 by welding. Alternatively, the rod 824 and retaining block 826 may be cast in a mold in one piece.

A space 824a for receiving the brake or clutch pedal shaft (the shaft is not shown in FIGS. 40-44) is formed between the retaining block 826 and the housing 816 and between the retaining block 826 and the rod 824. The rod 824 is slidable within the housing 816 so that the retaining block 826 is movable between a raised position and a retracted position, the retracted position being shown in solid lines in FIGS. 40-44. In the retracted position, the retaining block 826 is spaced from the pedal shaft, thus permitting the pedal shaft to be inserted into the space between the housing 816 and the retaining block 826. In the raised position (not shown) the retaining block 826 secures the pedal shaft and prevents the pedal shaft from being operably depressed, i.e., depressed sufficiently to enable the vehicle to be started and/or normally controlled.

Preferably, the retaining block 826 includes a beveled surface 826a which faces the rod 824 to facilitate positioning the pedal shaft within the space 824a formed between the retaining block 826 and the housing 816. The retaining block 826 is preferably made from a hardened tool steel or other similarly hard material. The advantage of the retaining block 826 is that it because of its size, construction, and the material from which it is made, it is extremely resistant to damage or tampering and thus, firmly secures the device 810 against attempts by an unauthorized user to disengage it from its position around the pedal shaft of a vehicle.

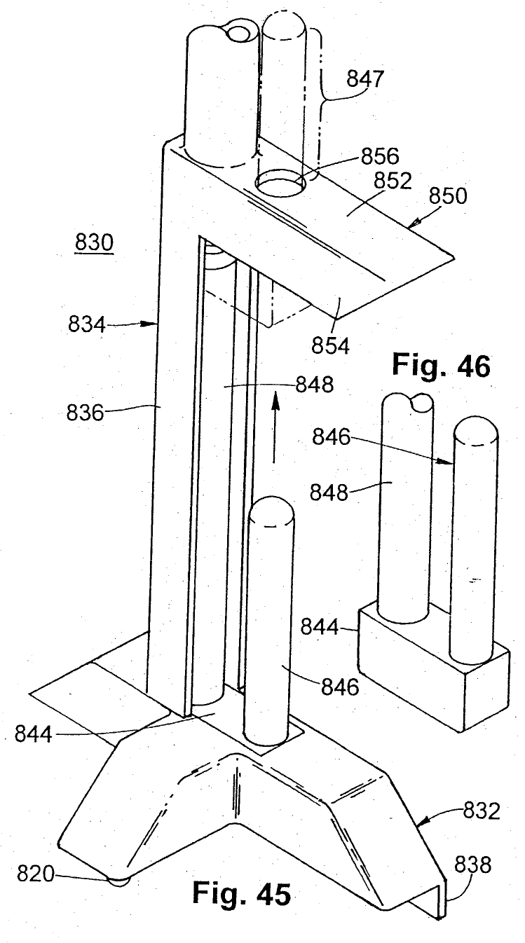

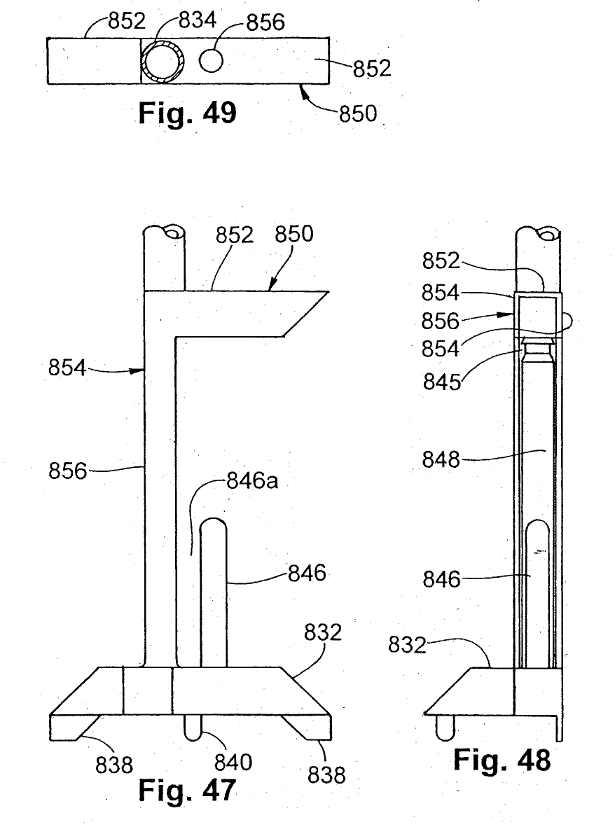

There is shown in FIGS. 45-49 an anti-theft device 830 in accordance with a sixteenth embodiment of the present invention. The device 830 comprises a base 832 for placement on a floor of a vehicle (not shown) and a housing 834 having an arm 836 attached to the base 832, with a cross member 850 extending generally perpendicularly from the arm 836. The cross member 850 has a pair of spaced apart vertical portions 854 and a horizontal portion 852 extending therebetween, with a hole 856 being formed in the horizontal portion 852 (See FIG. 48).

As with the fifteenth embodiment, the base preferably includes a combination of cleats 838 and studs 840. A gusset (not shown) may extend between the base 832 and the arm 836 to give the device 830 additional strength and resistance to tampering.

A rod 848, which is preferably partially serrated, is disposed within an opening 845 in the housing 834. Extending from one end of the rod 848 is a retaining post 846. Preferably, as is shown in FIGS. 45-49, a locking pin 844 extends from the one end of the rod 848, and the retaining post 846 extends from the locking pin 844. A space 846a for receiving the brake or clutch pedal shaft (the shaft is not shown in FIGS. 45-49) is formed between the retaining post 846 and the rod 848 and/or housing 834. The end of the cross member 850 may be beveled to ease insertion of the pedal shaft into the space 846a formed between the retaining post 846 and the rod 848.

The retaining post 846 is configured to be positioned in or inserted through the hole 856 in the horizontal portion 852 of the cross-member 850. The rod 848 is slidable within the arm 836 so that the retaining post 846 is movable between a raised position, shown in phantom in FIG. 45, and a retracted position, the retracted position shown in solid lines in FIGS. 45-49. As shown in phantom in FIG. 45, in the raised position the retaining post 846 is inserted through the hole 856 in the horizontal portion 852 of the cross-member 850 so that a top portion 847 of the retaining post 846 is substantially equal to or above the level of the horizontal portion 852 of the cross member 850. The retaining post 846 acts to close off the space 846a formed between the retaining post 846 and the housing 834, and prevents the pedal shaft from being pried or jostled out of the that space.

In the retracted position, the retaining post 846 is spaced a distance away from the cross member 850 to permit the pedal shaft to be inserted into or removed from the space between the cross member 850 and the retaining post 846.

This embodiment of the anti-theft device 830 provides a particularly secure enclosure for the pedal shaft. The pedal shaft is secured within a space defined by interlocking members (the retaining post 846, the rod 848 and the cross member 850). This interlocking relationship allows the retaining post 846 and cross member 850 to reinforce and strengthen the other in the event that a thief or unauthorized user should attempt to remove the pedal shaft from its secured position by tampering or damaging either of them.

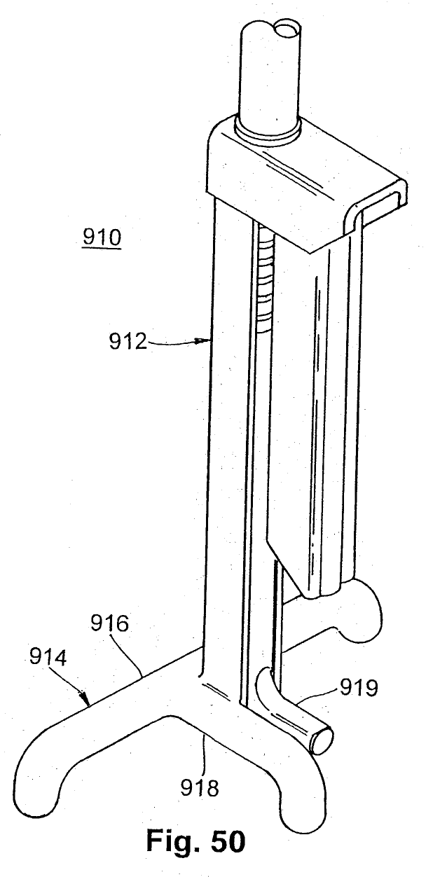

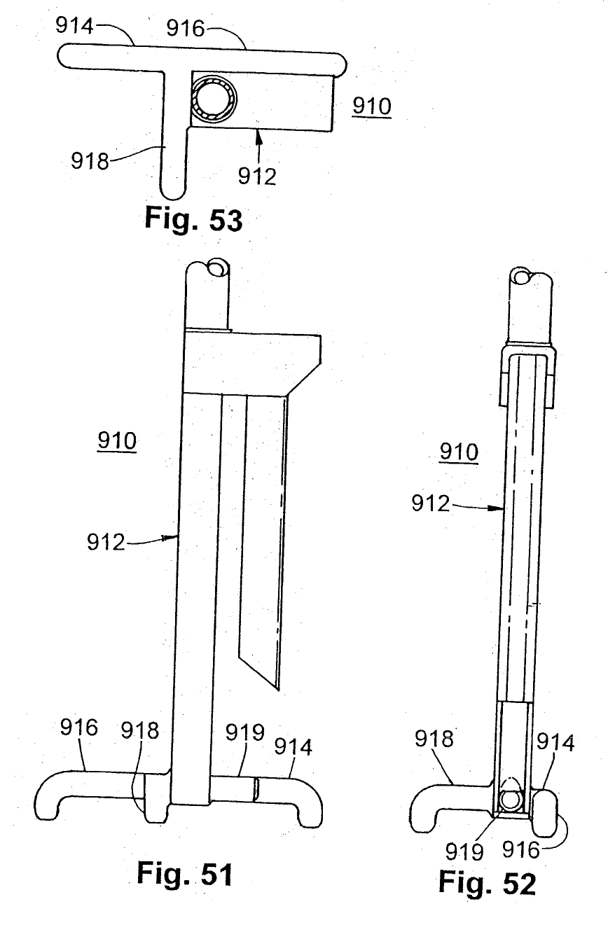

In FIGS. 50-53 there is shown an anti-theft device 910 in accordance with a seventeenth embodiment of the present invention for use with any of the embodiments disclosed herein. The anti-theft device 910 includes a base 914 for placement on a floor of a vehicle (not shown). A U-shaped housing 912 is attached to the base 914 as described above. A locking pin 919 contacts the underside of the brake or clutch pedal and pulls it upward in a decompressed fashion.

The base 914 is formed from at least two intersecting rods 916 and 918. Preferably the rods 916, 918 are generally in the form of a L-shape, each comprising two leg members arranged generally perpendicularly to each other with an arcuate portion extending between the two leg members. This forms a type of claw arrangement, that forms a tight, secure grasp on the floor surface of a vehicle to strengthen and enhance the secured position of the device 910 around the pedal shaft.

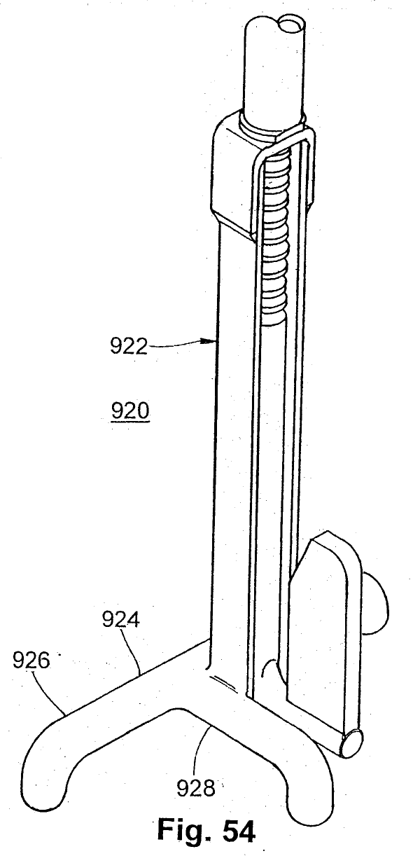

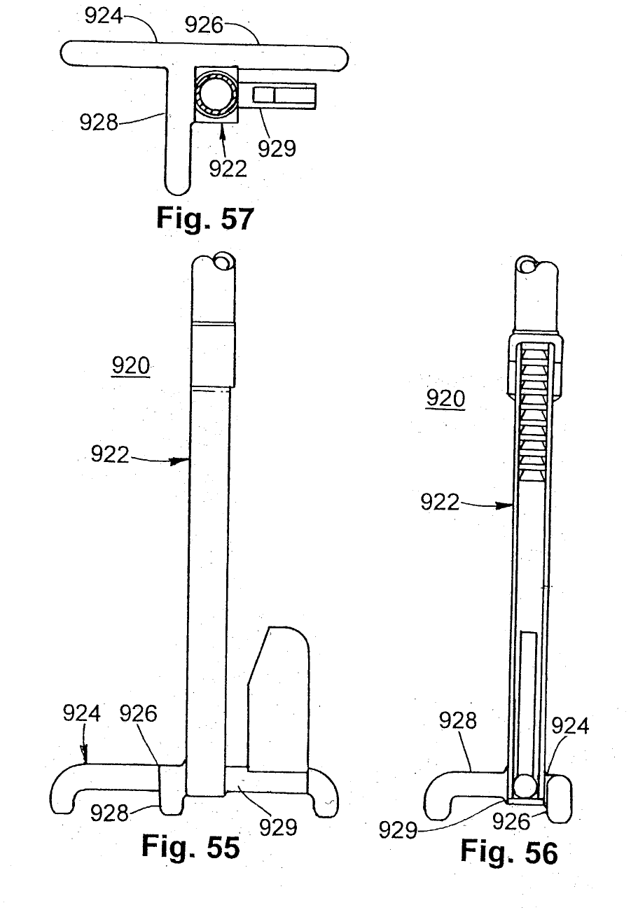

There is shown in FIGS. 54-57 an anti-theft device 920 in accordance with an eighteenth embodiment of the present invention. The eighteenth embodiment is generally identical to the sevententh embodiment, instead of using the U-shaped housing, a retaining block 927 is used, as described above in connection with the fifteenth embodiment shown in FIGS. 41-44.

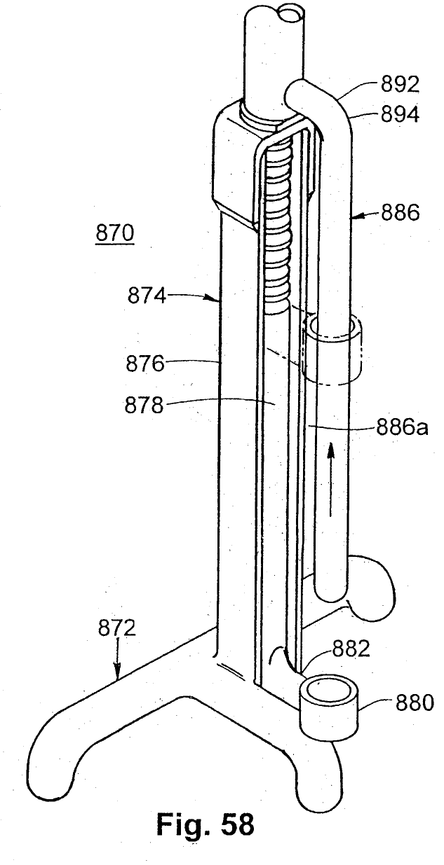

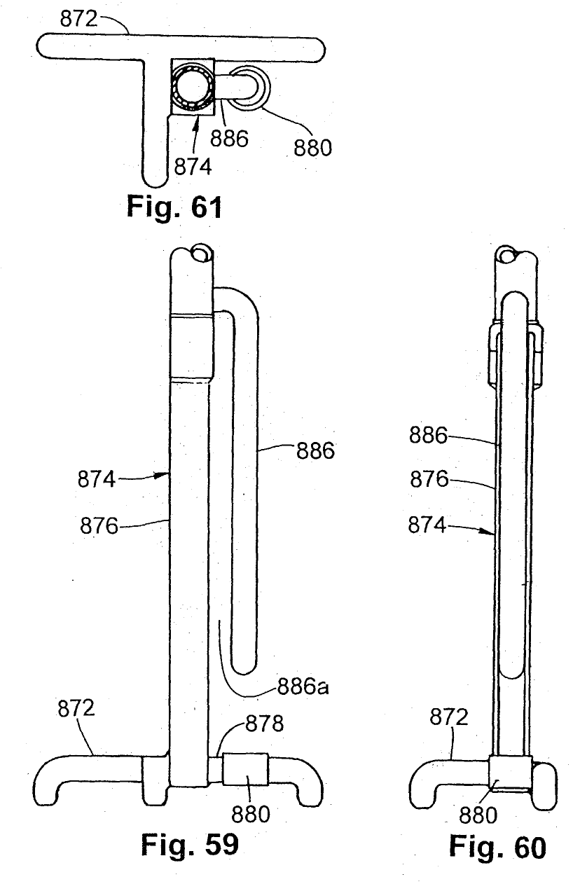

There is shown in FIGS. 58-61, an anti-theft device 870 in accordance with an nineteenth embodiment of the present invention. The device 870 includes a base 872 for placement on a floor of a vehicle (not shown) and a housing 874 having an arm 876 attached to the base 872. A descending member 886 extends from the arm 876 to define a space 886a between the arm 876 and the descending member 886 for receiving the pedal shaft (not shown).

A rod 878, which is partially serrated, is disposed within an opening in the housing 874. Preferably extending from one end of the rod 878 is a locking pin 882 selectively movable relative to the housing 874 with the rod 878. The locking pin 882 contacts the underside of the brake or clutch pedal and pulls it upward in a decompressed fashion to a raised position, the raised position being shown in phantom in FIG. 58. In the raised position, the pedal shaft is held by the locking pin 878 in the space defined between the descending member 886 and the housing 876 to prevent the pedal shaft from being operably depressed, i.e, depressed sufficiently to enable the vehicle to be started and/or normally controlled. Extending from the locking pin 878 is a ring 880 which is complementarily sized to slidably receive the descending member 886. The ring 880 is capable of sliding up and down upon the descending member 886 as illustrated in FIG. 58. The ring 880 closes the open space defined between the descending member 886 and the housing 876, and prevents a thief or tamperer from prying or slipping the pedal shaft out of the space formed between the housing 876 and the descending member 886. The ring 880 establishes an interlocking relationship between the descending member 886 and the housing 874. Thus, when an unauthorized user of the vehicle attempts to pry the descending member 886 member away from the housing by damaging or tampering with it in to remove the anti-theft device 870, the descending member 886 and the locking pin 882 each provide reinforcement to each other.

As illustrated in FIG. 58, the descending member 886 preferably comprises a first portion 892 that extends generally perpendicularly from the housing 874, and a second portion 896 that is arranged generally parallel to the arm 876. The first portion 829 is preferably welded to the housing 874. Preferably an arcuate portion 894 extends between the first portion 892 and the second portion 896. That is, the descending member 896 is preferably in the form of an L.

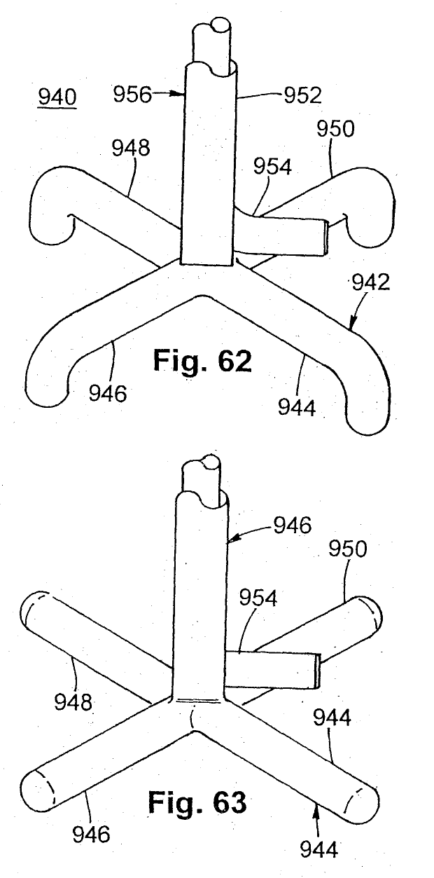

Shown in FIG. 62 is a twentieth embodiment of an anti-theft device 940 having a generally X-shaped base 942 for use with any of the embodiments disclosed herein. The X-shaped base 942 is formed from at least two legs. The X-shaped base 942 illustrated in FIG. 62 includes a first leg 944, a second leg 946, a third leg 948, and a fourth leg 950. Each of the first leg 944, second leg 946, third leg 948, and fourth leg 950 is in the form of a rod. More specifically, each of these legs is generally in the form of a L-shape, each comprising two leg members arranged generally perpendicularly to each other with an arcuate portion extending between the two leg members.

Shown in FIG. 62 is a twentieth embodiment of an anti-theft device 940 having a generally X-shaped base 942 for use with any of the embodiments disclosed herein. The X-shape base 942 is formed from at least two legs. The X-shaped base 942 illustrated in FIG. 62 includes a first leg 944, a second leg 946, a third leg 948, and a fourth leg 950. Each of the first leg 944, second leg 946, third leg 948, and fourth leg 950 are in the form of a rod, more specifically, each of these legs is generally in the form of a L-shape, each comprising two leg members arranged generally perpendicularly to each other with an arcuate portion extending between the two leg members.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A device to lock a brake or clutch pedal of a vehicle so as to deter theft of the vehicle, the device comprising:
a base for placement on a floor of the vehicle beneath the pedal of the vehicle and a pedal shaft supporting the pedal;
a housing having an arm attached to the base member, the arm having an opening therethrough;
a rod slidably disposed within said opening, the rod having a generally J-shaped end for receiving the brake or clutch pedal shaft, the rod being slidable within said arm so that the J-shaped end is movable between a raised position where the brake or clutch pedal cannot be depressed, and a retracted position, wherein the J-shaped end and is spaced from the clutch or brake pedal shaft; and
a locking mechanism operably connected to the rod to fix the J-shaped end in at least the raised position.

2. A device according to claim 1 wherein the J-shaped end further comprises a reinforcing buttress extending between the rod and the J-shaped end.

3. A device according to claim 2 wherein a gusset extends between the J-shaped end and the reinforcing buttress.

4. A device according to claim 1 wherein the J-shaped end comprises a terminal tip portion extending at an acute angle with respect to the rod.

5. A device according to claim 1 wherein the housing further comprises a cross member extending generally perpendicularly from the arm.

6. A device to lock a brake or clutch pedal of a vehicle so as to deter theft of the vehicle, the device comprising:
a generally U-shaped base for placement on a floor of the vehicle beneath the pedal of the vehicle and a pedal shaft supporting the pedal;
a housing attached to the base;
a locking pin selectively movable relative to the housing, which contacts the underside of the brake or clutch pedal and pulls it upwards in a decompressed fashion; and
a locking mechanism operably connected to the locking pin to secure the locking pin with respect to the housing and prevent the pedal shaft from being depressed.

7. The device according to claim 6 wherein the base has a first leg, a second leg, and a connector piece connecting the first leg to the second leg.

8. The device according to claim 7 wherein wherein the outboard ends of the first leg and the second leg are beveled at a 45 degree angle.

9. The device according to claim 6 wherein the base has a first leg, a second leg, and a connector piece longer than both the first leg and the second leg and connecting the first leg to the second leg.

10. A device to lock a brake or clutch pedal of a vehicle so as to deter theft of the vehicle, the device comprising:
a generally flat base for placement on a floor of the vehicle beneath the pedal of the vehicle and a pedal shaft supporting the pedal, wherein the base has a top side parallel to a bottom side to define a thickness between the top side and the bottom side;
a housing attached to the base member, this housing including a slot being sufficiently large to receive the pedal shaft and permit full extension of the pedal shaft upward through the slot;
a locking pin selectively movable relative to the housing between a raised position sufficiently close to a lower side of the pedal shaft to prevent the pedal shaft from being depressed from the full extension position and a retracted position to permit travel of the pedal shaft through the slot; and
a locking mechanism coupled to the housing and operably connected to the locking pin to fix the locking pin in at least the raised position.

11. The device according to claim 10 wherein the base has an edge beveled at a 45 degree angle.

12. The device according to claim 10 further comprising a plurality of gussets extending between the base member and the housing.

13. The device according to claim 10 further comprising a first gusset and a second gusset, wherein the first gusset and the second gusset are generally parallel to each other.

14. The device according to claim 10 further comprising at least three cleats extending perpendicularly from the bottom side of the base member.

15. A device to lock a brake or clutch pedal of a vehicle so as to deter theft of the vehicle, the device comprising:
a generally flat base for placement on a floor of the vehicle beneath the pedal of the vehicle and a pedal shaft supporting the pedal, wherein the base has a top side parallel to a bottom side to define a thickness between the top side and the bottom side;
a housing attached to the base member;
a locking pin selectively movable relative to the housing, which contacts the underside of the brake or clutch pedal and pulls it upwards in a decompressed fashion;
a locking mechanism operably connected to the locking pin to secure the locking pin with respect to the housing and prevent the pedal shaft from being depressed; and
at least three cleats extending perpendicularly from the bottom side of the base member.

16. A device to lock a brake or clutch pedal of a vehicle so as to deter theft of the vehicle, the device comprising:
a base for placement on a floor of the vehicle beneath the pedal of the vehicle and a pedal shaft supporting the pedal;
a housing attached to the base member;
a locking pin selectively movable relative to the housing, the locking pin having a first end that contacts the underside of the brake or clutch pedal and pulls it upward in a decompressed fashion and a second end that is generally in the form of a dowel;
a handle, including a hole for receiving the dowel, the hole being configured so as to form a complementary fit between the dowel and the hole; and
a locking mechanism operably connected to secure the locking pin with respect to the housing and prevent the pedal shaft from being depressed.

17. The device according to claim 16 further comprising an adhesive material that is applied between an exterior surface of the dowel and an interior surface of the hole.

18. A device to lock a brake or clutch pedal of a vehicle so as to deter theft of the vehicle, the device comprising:
a base for placement on a floor of the vehicle beneath the pedal of the vehicle and a pedal shaft supporting the pedal;
a housing having an arm attached to the base member, the arm having an opening therethrough;
a rod slidably disposed within said opening;
a locking pin which contacts the underside of the brake or clutch pedal shaft and pulls it upward in a decompressed fashion, the locking pin being securely fastened to one end of the rod; and
a locking mechanism operably connected to the rod to secure the locking pin with respect to the housing and to prevent the pedal shaft from being depressed.

19. The device according to claim 18 wherein the locking pin is secured to the rod with a threaded fastener.

20. The device according to claim 19 wherein a portion of the rod located near one end has a generally cylindrical shape, and a first end of the locking pin member has a complementary concave surface to permit the locking pin to be smoothly mated to the cylindrical surface of the portion of the rod.

21. The device according to claim 18 wherein the locking pin further comprises a gusset extending between the locking pin and the rod.

22. The device according to claim 21 wherein the gusset comprises a tab and the rod further includes a hole, the hole being configured so that the tab fits snugly inside the hole.

23. The device according to claim 21 wherein the shape of the gusset is generally triangular.

24. A device to lock a pedal of a vehicle so as to deter theft of the vehicle, the device comprising:
a base for placement on a floor of the vehicle beneath the pedal of the vehicle and a pedal shaft supporting the pedal;
a housing having an arm attached to the base member, the arm having a opening therethrough;
a rod slidably disposed within said opening and having a serrated portion, the serrated portion including a serration having a flat, radially-extending surface and a frusto-conical surface;
a locking pin on one end of the rod which contacts the underside of said pedal shaft and pulls it upward in a decompressed position;
a ratchet pin for engaging the serration having a beveled end upon which is formed a notch, the beveled end being configured to mate with the frusto-conical surface of the serration and the notch being formed to engage the flat radially-extending surface of the serration; and
a lock coupled to the housing and operably connected to the ratchet pin so that when the lock is in a locked position the ratchet pin engages the serration in order to secure the locking pin with respect to the housing and prevent the pedal shaft from being depressed.

25. The device according to claim 24, wherein the ratchet pin is constructed of tool steel.

26. A device to lock a brake or clutch pedal of a vehicle so as to deter theft of the vehicle, the device comprising:
a base for placement on the floor of a vehicle beneath the pedal of the vehicle and a pedal shaft supporting the pedal;
a housing attached to the base member;
a locking pin selectively movable relative to the housing, which contacts the underside of the brake or clutch pedal and pulls it upwards in a decompressed fashion;
a locking mechanism operably connected to the locking pin to secure the locking pin with respect to the housing and prevent the pedal shaft from being depressed; and
a plurality of gussets each extending between the arm and the housing.

27. The device according to claim 1 wherein the plurality of gussets comprises a first gusset and a second gusset and the second gusset is arranged generally perpendicular to the first gusset.

28. The device according to claim 27 further comprising a third gusset arranged generally co-planar to the first gusset.

29. The device according to claim 26 wherein the plurality of gussets comprises a first gusset and a second gusset and the second gusset is arranged generally co-planar to the first gusset.

30. The device according to claim 26 wherein the plurality of gussets comprises at least three gussets.

31. The device according to claim 26 wherein the base is a generally T-shaped base.

32. The device according to claim 26 wherein the base further comprises at least three cleats extending perpendicularly from the bottom side of the base.

33. A device to lock a brake or clutch pedal of a vehicle so as to deter theft of the vehicle, the device comprising:
a base for placement on a floor of the vehicle beneath the pedal of the vehicle and a pedal shaft supporting the pedal;
a housing attached to the base;
a locking pin selectively movable relative to the housing, which contacts the underside of said brake or clutch pedal shaft and pulls it upward in a decompressed position;
a handle on an opposing end of the locking pin, the handle being made in one piece and having a shape selected from the group consisting of spheres, ellipsoids, one sheet hyperboloids, elliptic paraboloids, and elliptic cyclinders; and
a locking mechanism operably connected to the locking pin to secure the locking pin with respect to the housing and prevent the pedal shaft from being depressed.

34. The device according to claim 33 wherein the shape is an ellipsoid.

35. A device to lock a brake or clutch pedal of a vehicle so as to deter theft of the vehicle, the device comprising:
a base for placement on a floor of the vehicle beneath the pedal of the vehicle and a pedal shaft supporting the pedal;
a housing attached to the base;
a locking pin selectively movable relative to the housing, which contacts the underside of said brake or clutch pedal shaft and pulls it upward in a decompressed position;
a handle on an opposing end of the locking pin, the handle being made in one piece and being in the form of a J-shape; and
a locking mechanism operably connected to the locking pin to secure the locking pin with respect to the housing and prevent the pedal shaft from being depressed.

36. A device to lock a brake or clutch pedal of a vehicle so as to deter theft of the vehicle, the device comprising:
a base for placement on a floor of the vehicle beneath the pedal of the vehicle and a pedal shaft supporting the pedal;
a housing having an arm attached to the base member, the arm having an opening therethrough;
a rod slidably disposed within said opening;
a retaining block extending from the rod to define a space between the rod and the retaining block, the space being sufficiently large to receive the pedal shaft, and the rod being slidable within said arm so that the retaining block is movable between a raised position where the brake or clutch pedal cannot be depressed, and a retracted position, wherein the retaining block is spaced from the clutch or brake pedal shaft; and
a locking mechanism operably connected to the rod to fix the retaining block in at least the raised position.

37. The device according to claim 36 wherein an end of the rod is in the form of a locking pin which contacts the underside of the pedal shaft, and the retaining block extends from the locking pin.

38. The device according to claim 36 wherein the retaining block includes an end portion beveled at an acute angle with respect to the rod.

39. The device according to claim 36 wherein the device comprises at least one gusset extending between the base and the housing.

40. The device according to claim 36 wherein a portion of the rod is serrated.

41. A device to lock a brake or clutch pedal of a vehicle so as to deter theft of the vehicle, the device comprising:
a base for placement on a floor of the vehicle beneath the pedal of the vehicle and a pedal shaft supporting the pedal;
a housing having an arm attached to the base member, the arm having an opening therethrough, and a cross member extending from the arm, a hole being formed in the cross member;
a rod slidably disposed within the opening of the housing; and
a retaining post, being configured to be positioned in the hole in the cross-member and extending from the rod to define a space between the rod and the retaining post, the space being sufficiently large to receive the pedal shaft, wherein the rod is slidable within said arm so that the retaining post is movable between a raised position where the brake or clutch pedal cannot be depressed and the retaining post is positioned through the hole in the cross-member and a retracted position, wherein the retaining post is spaced from the arm and the clutch or brake pedal shaft; and
a locking mechanism operably connected to the rod to fix the retaining post in at least the raised position.

42. The device according to claim 41 wherein a first end of the rod is in the form of a locking pin that contacts the underside of the pedal shaft, and the retaining post extends from the locking pin.

43. A device to lock a brake or clutch pedal of a vehicle so as to deter theft of the vehicle, the device comprising:
a base for placement on a floor of the vehicle beneath the pedal of the vehicle and a pedal shaft supporting the pedal, the base comprising at least two intersecting rods;
a housing attached to the base;
a locking pin selectively movable relative to the housing, which contacts the underside of said brake or clutch pedal shaft and pulls it upward in a decompressed position; and
a locking mechanism operably connected to the locking pin to secure the locking pin with respect to the housing and prevent the pedal shaft from being depressed.

44. The device according to claim 43 wherein each of the rods is generally in the form of a L-shape and comprises two leg members arranged generally perpendicularly to each other with an arcuate portion extending between the two leg members.

45. A device to lock a brake or clutch pedal of a vehicle so as to deter theft of the vehicle, the device comprising:
a base for placement on a floor of the vehicle beneath the pedal of the vehicle and a pedal shaft supporting the pedal;
a housing having an arm attached to the base member, the arm having an opening therethrough, and a descending member extending from the arm to define a slot between the arm and the descending member;
a locking pin selectively movable relative to the housing, the locking pin having an end that contacts the underside of the brake or clutch pedal and pulls it upward in a decompressed fashion;
a ring extending from the locking pin, the ring being complementarily sized to slidably receive the descending member; and
a locking mechanism operably connected to secure the locking pin with respect to the housing and prevent the pedal shaft from being depressed.

46. The device according to claim 45 wherein a portion of the descending member is arranged generally parallel to the arm.

47. The device according to claim 45 wherein the descending member comprises a first portion that extends generally perpendicularly from the arm, and a second portion that is arranged generally parallel to the arm.

48. The device according to claim 47 wherein the descending member further comprises a curved portion extending between the first portion and the second portion.

49. The device according to claim 45 wherein the descending member is generally in the form of a L-shape, a portion of the descending member being arranged generally parallel to the arm.

50. A device to lock a brake or clutch pedal of a vehicle so as to deter theft of the vehicle, the device comprising:
a generally X-shaped base for placement on a floor of the vehicle beneath the pedal of the vehicle and a pedal shaft supporting the pedal;
a housing attached to the base;
a locking pin selectively movable relative to the housing, which contacts the underside of the brake or clutch pedal and pulls it upwards in a decompressed fashion; and
a locking mechanism operably connected to the locking pin to secure the locking pin with respect to the housing and prevent the pedal shaft from being depressed.

51. The device according to claim 50 wherein the X-shaped base comprises at least two rods, and each of the rods is generally in the form of a L-shape and comprises two leg members arranged generally perpendicularly to each other with an arcuate portion extending between the two leg members.
